(19) United States
(12) Patent Application Publication
(10) Pub. No.: US 2010/0173900 A1
(43) Pub. Date: Jul. 8, 2010

(54) Strobilurins for Increasing the Resistance of Plants to Abiotic Stress

(75) Inventors: Harald Koehle, Bobenheim (DE); James Gaffney, Raleigh, NC (US); Thomas J. Holt, Holly Springs, NC (US); Hendrik Leonard Ypema, Cary, NC (US); Maria Cristina Pagani, Raleigh, NC (US)

Correspondence Address: BRINKS, HOFER, GILSON & LIONE, P.O. BOX 1340, MORRISVILLE, NC, 27560, US

(73) Assignee: BASF SE, Ludwigshafen (DE)

(21) Appl. No.: 12/666,021

(22) PCT Filed: Jun. 27, 2008
(86) PCT No.: PCT/EP08/58304

§ 371 Date: Dec. 22, 2009

(51) Int. Cl. A01N 43/88; A01N 43/54; A01N 37/18; A01N 43/40; A01N 37/02; A01N 43/56; A01N 37/44; A01P 21/00

(52) U.S. Cl. 514/229.2; 514/256; 514/620; 514/345; 514/546; 514/407; 514/567

(57) ABSTRACT

The present invention relates to a method for increasing the resistance of a plant or of a plant's seed to abiotic stress which method comprises treating the seed from which the plant is to grow with at least one strobilurin. The invention further relates to the use of at least one strobilurin for increasing the resistance of a plant or of a plant's seed to abiotic stress.

The present invention relates to a method for increasing the resistance of a plant or of a plant's seed to abiotic stress which method comprises treating the seed from which the plant is to grow with at least one strobilurin. The invention further relates to the use of at least one strobilurin for increasing the resistance of a plant or of a plant's seed to abiotic stress.

Abiotic stress is triggered in plants or their seeds for example by extreme temperatures such as heat, chill, great variations in temperature, or unseasonal temperatures, drought, extreme wetness, high salinity, radiation (for example increased UV radiation as the result of the diminishing ozone layer), increased amount of ozone in the vicinity of the soil and/or organic and inorganic pollution (for example as the result of phytotoxic amounts of pesticides or contamination with heavy metals). Abiotic stress leads to a reduced quantity and/or quality of the stressed plant and its fruits. Thus, for example, the synthesis and accumulation of proteins is mainly adversely affected by temperature stress, while growth and polysaccharide synthesis are reduced by virtually all stress factors. This leads to biomass losses and to a reduced nutrient content of the plant product. Extreme temperatures, in particular cold and chill, moreover delay germination and emergence of the seedlings and reduce the plant's height and its root length. A delayed germination and emergence often implicates a generally delayed development of the plant and for example a belated ripening. A reduced root length of the plant implies less nutrient uptake from the soil and less resistance to oncoming temperature extremes, in particular drought.

The current trend for sowing and planting ever earlier augments the plant's and the seed's risk to be exposed to abiotic stress, in particular chill.

It is therefore an object of the present invention to provide compounds which enhance a plant's or a plant's seed resistance to abiotic stress.

Surprisingly, it has been found that strobilurins have such a resistance-enhancing effect.

Accordingly, in a first aspect, the invention relates to a method for increasing the resistance of a plant or of a plant's seed to abiotic stress which method comprises treating the seed from which the plant is to grow with at least one strobilurin.

In a second aspect, the invention relates to the use of at least one strobilurin as defined above for increasing the resistance of a plant or of a plant's seed to abiotic stress.

Naturally, the terms “whose seeds” and “the seeds of which” relate to the seed from which the plant has been grown or is to grow and not the seed which it produces itself.

The term “seed” represents all types of plant propagation material. It comprises seeds in the actual sense, grains, fruits, tubers, the rhizome, spores, cuttings, slips, meristem tissue, individual plant cells and any form of plant tissue from which a complete plant can be grown. Preferably, it takes the form of seed in the actual sense.

“Growing medium”, “growth medium” or “growth substrate” refers to any type of substrate in which the seed is sown and the plant grows or will grow, such as soil (for example in a pot, in borders or in the field) or artificial media. As a rule, it takes the form of the soil.

The organic moieties mentioned in the below definitions of the variables are—like the term halogen—collective terms for individual listings of the individual group members. The prefix Cₙ-Cₘ indicates in each case the possible number of carbon atoms in the group.

Halogen will be taken to mean fluoro, chloro, bromo and iodo, preferably fluoro, chloro, and bromo and in particular fluoro and chloro.

C₁-C₄-Alkyl is a linear or branched alkyl group having 1 to 4 carbon atoms. Examples are methyl, ethyl, propyl, isopropyl, n-butyl, sec-butyl, isobutyl and tert-butyl. C₁-C₈-Alkyl is a linear or branched alkyl group having 1 to 8 carbon atoms. Examples are, additionally to those mentioned for C₁-C₄-alkyl, pentyl, 1-methylbutyl, 2-methylbutyl, 3-methylbutyl, 2,2-dimethylpropyl, 1-ethylpropyl, 1,1-dimethylpropyl, 1,2-dimethylpropyl, hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, heptyl, octyl, 2-ethylhexyl and positional isomers thereof.

C₁-C₈-Haloalkyl is a linear or branched alkyl group having 1 to 8 carbon atoms, preferably 1 to 4 carbon atoms (═C₁-C₄-haloalkyl), as defined above, wherein at least one hydrogen atom is replaced by a halogen atom. C₁-C₂-Haloalkyl is, for example chloromethyl, bromomethyl, dichloromethyl, trichloromethyl, fluoromethyl, difluoromethyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, pentafluoroethyl and the like. C₁-C₄-Haloalkyl is, additionally to the examples mentioned for C₁-C₂-haloalkyl, for example 2-fluoropropyl, 3-fluoropropyl, 2,2-difluoropropyl, 2,3-difluoropropyl, 2-chloropropyl, 3-chloropropyl, 2,3-dichloropropyl, 2-bromopropyl, 3-bromopropyl, 3,3,3-trifluoropropyl, 3,3,3-trichloropropyl, CH₂-C₂F₅, CF₂-C₂F₅, 1-(CH₂F)-2-fluoroethyl, 1-(CH₂Cl)-2-chloroethyl, 1-(CH₂Br)-2-bromoethyl, 4-fluorobutyl, 4-chlorobutyl, 4-bromobutyl or nonafluorobutyl. C₁-C₆-Haloalkyl is additionally, for example, 5-fluoropentyl, 5-chloropentyl, 5-bromopentyl, 5-iodopentyl, undecafluoropentyl, 6-fluorohexyl, 6-chlorohexyl, 6-bromohexyl, 6-iodohexyl or dodecafluorohexyl.

C₁-C₄-Hydroxyalkyl represents a C₁-C₄-alkyl radical in which at least one hydrogen atom is replaced by a hydroxyl group. Examples are hydroxymethyl, 1- and 2-hydroxyethyl, 1,2-dihydroxyethyl, 1-, 2- and 3-hydroxypropyl, 1,2-dihydroxypropyl, 1,3-dihydroxypropyl, 2,3-dihydroxypropyl, 1,2,3-trihydroxypropyl, 1-, 2-, 3- and 4-hydroxybutyl and the like.

C₁-C₄-Alkoxy represents a C₁-C₄-alkyl radical which is bonded via an oxygen atom. Examples are methoxy, ethoxy, propoxy, isopropoxy, n-butoxy, sec-butoxy, isobutoxy and tert-butoxy. C₁-C₈-Alkoxy represents a C₁-C₈-alkyl radical which is bonded via an oxygen atom. Examples are, additionally to those mentioned for C₁-C₄-alkoxy, pentyl-oxy, hexyloxy, heptyloxy, octyloxy, 2-ethylhexyloxy and positional isomers thereof.

C₁-C₈-Haloalkoxy represents a C₁-C₈-alkoxy radical as mentioned above which is partially or fully substituted by fluorine, chlorine, bromine and/or iodine, preferably by fluorine. C₁-C₂-Haloalkoxy is, for example, OCH₂F, OCHF₂, OCF₃, OCH₂Cl, OCHCl₂, OCCl₃, chlorofluoromethoxy, dichlorofluoromethoxy, chlorodifluoromethoxy, 2-fluoroethoxy, 2-chloroethoxy, 2-bromoethoxy, 2-iodoethoxy, 2,2-difluoroethoxy, 2,2,2-trifluoroethoxy, 2-chloro-2-fluoroethoxy, 2-chloro-2,2-difluoroethoxy, 2,2-dichioro-2-fluoroethoxy, 2,2,2-trichloroethoxy or OC₂F₅. C₁-C₄-Haloalkoxy is additionally, for example, 2-fluoropropoxy, 3-fluoropropoxy, 2,2-difluoropropoxy, 2,3-difluoropropoxy, 2-chloropropoxy, 3-chloropropoxy, 2,3-dichloropropoxy, 2-bromopropoxy, 3-bromopropoxy, 3,3,3-trifluoropropoxy, 3,3,3-trichloropropoxy, OCH₂-C₂F₅, OCF₂-C₂F₅, 1-(CH₂F)-2-fluoroethoxy, 1-(CH₂Cl)-2-chloroethoxy, 1-(CH₂Br)-2-bromoethoxy, 4-fluorobutoxy, 4-chlorobutoxy, 4-bromobutoxy or nonafluorobutoxy. C₁-C₆-Haloalkoxy is additionally, for example, 5-fluoropentoxy, 5-chloropentoxy, 5-bromopentoxy, 5-iodopentoxy, undecafluoropentoxy, 6-fluorohexoxy, 6-chlorohexoxy, 6-bromohexoxy, 6-iodohexoxy or dodecafluorohexoxy.

C₁-C₄-Alkoxy-C₁-C₄-alkyl represents a C₁-C₄-alkyl radical in which at least one hydrogen atom is replaced by a C₁-C₄-alkoxy group. Examples are methoxymethyl, ethoxymethyl, propoxymethyl, isopropoxymethyl, butoxymethyl, sec-butoxymethyl, isobutoxymethyl, tert-butoxymethyl, methoxyethyl, 1- and 2-ethoxyethyl, 1- and 2-propoxyethyl, 1- and 2-isopropoxyethyl, 1- and 2-butoxyethyl, 1- and 2-sec-butoxy-ethyl, 1- and 2-isobutoxyethyl, 1- and 2-tert-butoxyethyl, 1-, 2- and 3-methoxypropyl, 1-, 2- and 3-ethoxypropyl, 1-, 2- and 3-propoxypropyl, 1-, 2- and 3-isopropoxypropyl, 1-, 1- and 3-butoxypropyl, 1-, 2- and 3-sec-butoxypropyl, 1-, 2- and 3-isobutoxypropyl, 1-, 1- and 3-tert-butoxypropyl and the like.

Hydroxy-C₁-C₄-alkoxy-C₁-C₄-alkyl represents a C₁-C₄-alkyl radical, in which at least one hydrogen atom is replaced by at least one C₁-C₄-alkoxy group. In addition, at least one hydrogen atom in the alkyl radical or in the alkoxy radical or in both is replaced by a hydroxyl group. Examples are (2-hydroxyethoxy)methyl, (2- and 3-hydroxypropoxy)-methyl, (2-hydroxyethoxy)ethyl, (2- and 3-hydroxypropoxy)-1-ethyl, (2- and 3-hydroxy-propoxy)-2-ethyl, 2-ethoxy-1-hydroxyethyl and the like.

C₁-C₄-Alkylthio is a C₁-C₄-alkyl radical as defined above which is bonded via a sulfur atom. Examples are methylthio, ethylthio, propylthio, isopropylthio, n-butylthio, sec-butylthio, isobutylthio and tert-butylthio. C₁-C₈-Alkylthio is a C₁-C₈-alkyl radical as defined above which is bonded via a sulfur atom. Examples are, additionally to those mentioned for C₁-C₄-alkylthio, pentylthio, 1-methylbutylthio, 2-methylbutylthio, 3-methylbutylthio, 2,2-dimethylpropylthio, 1-ethylpropylthio, 1,1-dimethylpropylthio, 1,2-dimethylpropylthio, hexylthio, 1-methylpentylthio, 2-methylpentylthio, 3-methylpentylthio, 4-methylpentylthio, 1,1-dimethylbutylthio, 1,2-dimethylbutylthio, 1,3-dimethylbutylthio, 2,2-dimethylbutylthio, 2,3-dimethylbutylthio, 3,3-dimethylbutylthio, 1-ethylbutylthio, 2-ethylbutylthio, 1,1,2-trimethylpropylthio, 1,2,2-trimethylpropylthio, 1-ethyl-1-methylpropylthio, 1-ethyl-2-methylpropylthio, heptylthio, octylthio, 2-ethylhexylthio and positional isomers thereof.

C₁-C₈-Haloalkylthio is a linear or branched C₁-C₈-alkyl radical which is bonded via a sulfur atom and in which one or more hydrogen atoms are replaced by a halogen atom, in particular by fluorine or chlorine. Examples are chloromethylthio, dichloromethylthio, trichloromethylthio, fluoromethylthio, difluoromethylthio, trifluoromethylthio, bromomethylthio, chlorofluoromethylthio, dichlorofluoromethylthio, chlorodifluoromethylthio, 1-chloroethylthio, 1-bromoethylthio, 1-fluoroethylthio, 2-chloroethylthio, 2-bromoethylthio, 2-fluoroethylthio, 2,2-difluoroethylthio, 2-chloro-2-fluoroethylthio, 2,2-dichloroethylthio, 2,2,2-trichloroethylthio, 2,2,2-trifluoroethylthio, pentafluoroethylthio, pentachloroethylthio and the like.

Cₘ-Cₙ-Alkylthio-Cₘ-Cₙ-alkyl is a Cₘ-Cₙ-alkyl group in which one hydrogen atom is replaced by a Cₘ-Cₙ-alkylthio group. Accordingly, C₁-C₈-alkylthio-C₁-C₈-alkyl is a C₁-C₈-alkyl group in which one hydrogen atom is replaced by a C₁-C₈-alkylthio group. Examples are methylthiomethyl, ethylthiomethyl, propylthiomethyl, methylthioethyl, ethylthioethyl, propylthioethyl, methylthiopropyl, ethylthiopropyl, propyithiopropyl and the like.

Cₘ-Cₙ-Haloalkylthio-Cₘ-Cₙ-alkyl is a Cₘ-Cₙ-alkyl group in which one hydrogen atom is replaced by a Cₘ-Cₙ-haloalkylthio group. Accordingly, C₁-C₈-haloalkylthio-C₁-C₈-alkyl is a C₁-C₈-alkyl group in which one hydrogen atom is replaced by a C₁-C₈-haloalkylthio group. Examples are chloromethylthiomethyl, dichloromethylthiomethyl, trichloromethylthiomethyl, chloroethylthiomethyl, dichloroethylthiomethyl, trichloroethylthiomethyl, tetrachloroethylthiomethyl, pentachloroethylthiomethyl and the like.

Carboxyl is a group —COOH.

C₁-C₈-Alkylcarbonyl is a group —CO—R in which R is C₁-C₈-alkyl.

C₁-C₈-Alkyloxycarbonyl (also referred to as C₁-C₈-alkoxycarbonyl) is a group —C(O)O—R in which R is C₁-C₈-alkyl.

C₁-C₈-Alkylcarbonyloxy is a group —OC(O)—R in which R is C₁-C₈-alkyl.

C₁-C₈-Alkylaminocarbonyl is a group —CO—NH—R in which R is C₁-C₈-alkyl.

Di(C₁-C₈-alkyl)aminocarbonyl is a group —CO—N(RR′) in which R and R′, independently of one another, are C₁-C₈-alkyl.

C₂-C₈-Alkenyl is a linear or branched hydrocarbon having 2 to 8 carbon atoms and one double bond in any position. Examples are ethenyl, 1-propenyl, 2-propenyl (allyl), 1-methylethenyl, 1-, 2- and 3-butenyl, 1-methyl-1-propenyl, 2-methyl-1-propenyl, 1-, 2-, 3- and 4-pentenyl, 1-, 2-, 3-, 4- and 5-hexenyl, 1-, 2-, 3-, 4-, 5- and 6-heptenyl, 1-, 2-, 3-, 4-, 5-, 6- and 7-octenyl and their constitutional isomers.

C₂-C₈-Alkenyloxy is a C₂-C₈-alkenyl radical which is bonded via an oxygen atom. Examples are ethenyloxy, propenyloxy and the like.

C₂-C₈-Alkenylthio is a C₂-C₈-alkenyl radical which is bonded via a sulfur atom. Examples are ethenylthio, propenylthio and the like.

C₂-C₈-Alkenylamino is a group —NH—R in which R is C₂-C₈-alkenyl.

N—C₂-C₈-Alkenyl-N—C₁-C₈-alkylamino is a group —N(RR′) in which R is C₂-C₈-alkenyl and R′ is C₁-C₈-alkyl.

C₂-C₈-Alkynyl is a linear or branched hydrocarbon having 2 to 8 carbon atoms and at least one triple bond. Examples are ethynyl, propynyl, 1- and 2-butynyl and the like.

C₂-C₈-Alkynyloxy is a C₂-C₈-alkynyl radical which is bonded via an oxygen atom. Examples are propynyloxy, butynyloxy and the like.

C₂-C₈-Alkenylthio is a C₂-C₈-alkynyl radical which is bonded via a sulfur atom. Examples are ethynylthio, propenylthio and the like.

C₂-C₈-Alkynylamino is a group —NH—R in which R is C₂-C₈-alkynyl.

N—C₂-C₈-Alkynyl-N—C₁-C₈-alkylamino is a group —N(RR′) in which R is C₂-C₈-alkynyl and R′ is C₁-C₈-alkyl.

C₃-C₈-Cycloalkyl is a monocyclic 3- to 8-membered saturated cycloaliphatic radical. Examples are cyclopropyl, cyclobutyl, cyclopentyl, cyclohexyl, cycloheptyl and cyclooctyl.

C₃-C₈-Cycloalkyloxy (or C₃-C₈-cycloalkoxy) is a C₃-C₈-cycloalkyl radical which is bonded via oxygen. Examples are cyclopropyloxy, cyclobutyloxy, cyclopentyloxy, cyclohexyloxy, cycloheptyloxy and cyclooctyloxy.

C₃-C₈-Cycloalkylthio is a C₃-C₈-cycloalkyl radical which is bonded via a sulfur atom. Examples are cyclopropylthio, cyclobutylthio, cyclopentylthio, cyclohexylthio, cycloheptylthio and cyclooctylthio.

C₃-C₈-Cycloalkylamino is a group —NH—R in which R is C₃-C₈-cycloalkyl.

N—C₃-C₈-Cycloalkyl-N—C₁-C₈-alkylamino is a group —N(RR′) in which R is C₃-C₈-cyclo-alkyl and R′ is C₁-C₈-alkyl.

C₃-C₈-Cycloalkenyl is a monocyclic 3- to 8-membered unsaturated cycloaliphatic radical having at least one double bond. Examples are cyclopropenyl, cyclobutenyl, cyclopentenyl, cyclopentadienyl, cyclohexyl, cyclohexadienyl, cycloheptenyl, cycloheptadienyl, cyclooctyl, cyclooctadienyl, cyclooctatrienyl and cyclooctatetraenyl.

C₃-C₈-Cycloalkenyloxy is a C₃-C₈-cycloalkenyl radical which is bonded via oxygen. Examples are cyclopropenyloxy, cyclobutenyloxy, cyclopentenyloxy, cyclopentadienyloxy, cyclohexenyloxy, cyclohexadienyloxy, cycloheptenyloxy, cycloheptadienyloxy, cyclooctenyloxy, cyclooctadienyloxy, cyclooctatrienyloxy and cyclooctatetraenyloxy.

Cₘ-Cₙ-Alkylene is a linear or branched alkylene group having m to n, for example 1 to 8, carbon atoms. Thus, C₁-C₃-alkylene is, for example, methylene, 1,1- or 1,2-ethylene, 1,1-, 1,2-, 2,2- or 1,3-propylene. C₂-C₄-Alkylene is, for example, 1,1- or 1,2-ethylene, 1,1-, 1,2-, 2,2- or 1,3-propylene, 1,1-, 1,2-, 1,3- or 1,4-butylene. C₃-C₅-Alkylene is, for example, 1,1-, 1,2-, 2,2- or 1,3-propylene, 1,1-, 1,2-, 1,3- or 1,4-butylene, 1,1-dimethyl-1,2-ethylene, 2,2-dimethyl-1,2-ethylene, 1,1-, 1,2-, 1,3-, 1,4- or 1,5-pentylene and the like.

Oxy-Cₘ-Cₙ-alkylene is a group —O—R— in which R is Cₘ-Cₙ-alkylene. Thus, oxy-C₂-C₄-alkylene is a group —O—R— in which R is C₂-C₄-alkylene. Examples are oxy-1,2-ethylene, oxy-1,3-propylene and the like.

Oxy-Cₘ-Cₙ-alkylenoxy is a group —O—R—O— in which R is Cₘ-Cₙ-alkylene. Thus, oxy-C₁-C₃-alkylenoxy is a group —O—R—O— in which R is C₁-C₃-alkylene. Examples are oxymethylenoxy, oxy-1,2-ethylenoxy, oxy-1,3-propylenoxy and the like.

Cₘ-Cₙ-Alkenylene is a linear or branched alkenylene group having m to n, for example 2 to 8, carbon atoms. Thus, C₂-C₄-alkylene is, for example, 1,1- or 1,2-ethenylene, 1,1-, 1,2- or 1,3-propenylene, 1,1-, 1,2-, 1,3- or 1,4-butylene. C₃-C₅-Alkenylene is, for example, 1,1-, 1,2- or 1,3-propenylene, 1,1-, 1,2-, 1,3- or 1,4-butenylene, 1,1-, 1,2-, 1,3-, 1,4- or 1,5-pentenylene and the like.

Oxy-Cₘ-Cₙ-alkenylene is a group —O—R— in which R is Cₘ-Cₙ-alkenylene. Thus, oxy-C₂-C₄-alkenylene is a group —O—R— in which R is C₂-C₄-alkenylene. Examples are oxy-1,2-ethenylene, oxy-1,3-propenylene and the like.

Oxy-Cₘ-Cₙ-alkenylenoxy is a group —O—R—O— in which R is Cₘ-Cₙ-alkenylene. Thus, oxy-C₂-C₄-alkenylenoxy is a group —O—R—O— in which R is C₂-C₄-alkenylene. Examples are oxy-1,2-ethenylenoxy, oxy-1,3-propenylenoxy and the like.

Aryl is an aromatic hydrocarbon having 6 to 14 carbon atoms, such as phenyl, naphthyl, anthracenyl or phenanthrenyl and is in particular phenyl.

Aryloxy is an aryl radical which is bonded via an oxygen atom. One example is phenoxy.

Arylthio is an aryl radical which is bonded via a sulfur atom. One example is phenylthio.

Aryl-C₁-C₈-alkyl is a C₁-C₈-alkyl radical in which one hydrogen atom is substituted by an aryl group. Examples are benzyl and 2-phenylethyl.

Aryl-C₂-C₈-alkenyl is a C₂-C₈-alkenyl radical in which one hydrogen atom is substituted by an aryl group. One example is 2-phenylethenyl (styryl).

Aryl-C₂-C₈-alkynyl is a C₂-C₈-alkynyl radical in which one hydrogen atom is substituted by an aryl group. One example is 2-phenylethynyl.

Aryl-C₁-C₈-alkoxy is a C₁-C₈-alkoxy radical in which one hydrogen atom is replaced by an aryl group. One example is benzyloxy (benzoxy).

Heterocyclyl is a nonaromatic saturated or unsaturated or aromatic (“hetaryl”) heterocyclyl radical having preferably 3 to 7 ring members. The ring members comprise 1, 2, 3 or 4 hetero atoms selected from among O, N and S and/or hetero atom groups selected from among SO, SO₂ and NR, where R is H or C₁-C₈-alkyl, and optionally also 1, 2 or 3 carbonyl groups. Examples of nonaromatic heterocyclyl groups comprise aziridinyl, azetidinyl, pyrrolidinyl, pyrrolidinonyl, pyrrolidinedionyl, pyrazolinyl, pyrazolinonyl, imidazolinyl, imidazolinonyl, imidazolinedionyl, pyrrolinyl, pyrrolinonyl, pyrrolinedionyl, pyrazolinyl, imidazolinyl, imidazolinonyl, tetrahydrofuranyl, dihydrofuranyl, 1,3-dioxolanyl, dioxolenyl, thiolanyl, dihydrothienyl, oxazolidinyl, isoxazolidinyl, oxazolinyl, isoxazolinyl, thiazolinyl, isothiazolinyl, thiazolidinyl, isothiazolidinyl, oxathiolanyl, piperidinyl, piperidinonyl, piperidinedionyl, piperazinyl, pyridinonyl, pyridinedionyl, pyridazinonyl, pyridazinedionyl, pyrlmidinonyl, pyridazinedionyl, pyranyl, dihydropyranyl, tetrahydropyranyl, dioxanyl, thiopyranyl, dihydrothiopyranyl, tetrahydrothiopyranyl, morpholinyl, thiazinyl and the like. Aromatic heterocyclyl groups (=hetaryl) are preferably 5- or 6-membered. Examples comprise pyrrolyl, furyl, thienyl, pyrazolyl, imidazolyl, triazolyl, tetrazolyl, oxazolyl, isoxazolyl, thiazolyl, isothiazolyl, thiadiazolyl, oxadiazolyl, pyridyl, pyridazinyl, pyrimidinyl, pyrazinyl and triazinyl.

Heterocyclyloxy or hetaryloxy is a heterocyclyl, or hetaryl, radical which is bonded via an oxygen atom.

Hetaryl-C₁-C₈-alkyl is a C₁-C₈-alkyl radical in which one hydrogen atom is substituted by a hetaryl group. Examples are pyrrolylmethyl, pyridinylmethyl and the like.

Hetaryl-C₂-C₈-alkenyl is a C₂-C₈-alkenyl radical in which one hydrogen atom is substituted by a hetaryl group.

Hetaryl-C₂-C₈-alkynyl is a C₂-C₈-alkynyl radical in which one hydrogen atom is substituted by a hetaryl group.

Hetaryl-C₁-C₈-alkoxy is a C₁-C₈-alkoxy radical in which one hydrogen atom is substituted by a hetaryl group.

The remarks made below as to preferred embodiments of the strobilurins and other features of the invention are to be taken either alone or, preferably, in combination with each other.

Strobilurins are fungicidally active compounds which are derived from natural strobilurins, defense substances which are produced by fungi of the genus Strobilurus. As regards their structure, they generally comprise 1.) at least one functional group which is selected among enol ethers, oxime ethers and O-alkylhydroxylamines (group I) and 2.) at least one carboxyl derivative or a keto group (group II). Preferred carboxyl derivatives are the following functional groups: ester, cyclic ester, amide, cyclic amide, hydroxamic acid and cyclic hydroxamic acid. Preferably, the group I radicals and the group II radicals are directly adjacent to one another, i.e. linked via a single bond. Some strobilurins comprise only one of group I or II functional groups.

Preferred strobilurins are compounds of the formulae IA or IB

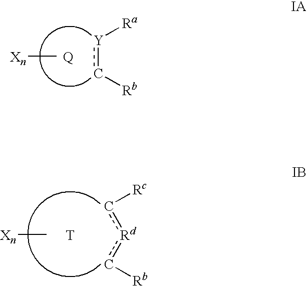

in which
[symbol] is a double bond or single bond;
R^{a} is —C[CO₂CH₃]═CHOCH₃, —C[CO₂CH₃]═NOCH₃, —C[CONHCH₃]═NOCH₃, —C[CO₂CH₃]═CHCH₃, —C[CO₂CH₃]═CHCH₂CH₃, —C[CO₂CH₃]═NOCH₃, —C[COCH₂CH₃]═NOCH₃, —C[C(═N—OR⁸²)OR⁸⁴]═NOCH₃, —N(OCH₃)—CO₂CH₃, —N(CH₃)—CO₂CH₃ or —N(CH₂CH₃)—CO₂CH₃, wherein R^{μ}and R⁸⁴ independently are H, methyl or ethyl or together form a group CH₂ or CH₂CH₂;
R^{b} is an organic radical which is bonded directly or via an oxygen atom, a sulfur atom, an amino group or a C₁-C₈-alkylamino group; or
together with a group X and the ring Q or T, to which R^{b} and X are bonded, forms an optionally substituted bicyclic, partially or fully unsaturated system which, in addition to carbon ring members, may comprise 1, 2 or 3 heteroatoms which are independently selected among oxygen, sulfur and nitrogen;
R^{c} is —OC[CO₂CH₃]═CHOCH₃, —OC[CO₂CH₃]═CHCH₃, —OC[CO₂CH₃]═CHCH₂CH₃, —SC[CO₂CH₃]═CHOCH₃, —SC[CO₂CH₃]═CHCH₃, —SC[CO₂CH₃]═CHCH₂CH₃, —N(CH₃)C[CO₂CH₃]═CHOCH₃, —N(CH₃)C[CO₂CH₃]═NOCH₃, —CH₂C[CO₂CH₃]═CHOCH₃, —CH₂C[CO₂CH₃]═NOCH₃, —CH₂C[CONHCH₃]═NOCH₃ or —CH₂NR^{π}[CO₂CH₃], where R^{π} is H, methyl or methoxy;
R^{d} is oxygen, sulfur, ═CH— or ═N—;
n is 0, 1, 2 or 3, where, if n>1, the radicals X can be identical or different;
X is cyano, nitro, halogen, C₁-C₈-alkyl, C₁-C₈-haloalkyl, C₁-C₈-alkoxy, C₁-C₈-haloalkoxy or C₁-C₈-alkylthio, or
   if n>1, two radicals X bonded to two adjacent C atoms of the Q or T ring can also be a C₃-C₅-alkylene, C₃-C₅-alkenylene, oxy-C₂-C₄-alkylene, oxy-C₁-C₃-alkylenoxy, oxy-C₂-C₄-alkenylene, oxy-C₂-C₄-alkenylenoxy or butadienediyl group, it being possible for these chains, in turn, to have attached to them one to three radicals which are independently of one another selected among halogen, C₁-C₈-alkyl, C₁-C₈-haloalkyl, C₁-C₈-alkoxy, C₁-C₈-haloalkoxy and C₁-C₈-alkylthio;
Y is ═C— or —N—;
Q is phenyl, pyrrolyl, thienyl, furyl, pyrazolyl, imidazolyl, oxazolyl, isoxazolyl, thiazolyl, thiadiazolyl, triazolyl, pyridinyl, 2-pyridonyl, pyrimidinyl or triazinyl; and
T is phenyl, oxazolyl, thiazolyl, thiadiazolyl, oxadiazolyl, pyridinyl, pyrimidinyl or triazinyl.

Owing to the basic nitrogen atoms in compounds IA or IB wherein Q or T is an azole or a pyridinyl, pyrimidinyl or triazinyl moiety, the compounds of the formulae IA and IB are capable of forming salts or adducts with inorganic or organic acids or with metal ions. They can be formed in a customary method, e.g. by reacting the compounds with an acid of the anion in question.

Suitable agriculturally useful salts are especially the salts of those cations or the acid addition salts of those acids the cations and anions of which do not have any adverse effect on the action of the compounds according to the present invention. Suitable cations are in particular the ions of the alkali metals, preferably lithium, sodium and potassium, of the alkaline earth metals, preferably calcium, magnesium and barium, and of the transition metals, preferably manganese, copper, zinc and iron, and also ammonium (NH₄⁺) and substituted ammonium in which one to four of the hydrogen atoms are replaced by C₁-C₄-alkyl, C₁-C₄-hydroxyalkyl, C₁-C₄-alkoxy, C₁-C₄-alkoxy-C₁-C₄-alkyl, hydroxy-C₁-C₄-alkoxy-C₁-C₄-alkyl, phenyl or benzyl. Examples of substituted ammonium ions comprise methylammonium, isopropylammonium, dimethylammonium, diisopropylammonium, trimethylammonium, tetramethylammonium, tetraethylammonium, tetrabutylammonium, 2-hydroxyethylammonium, 2-(2-hydroxyethoxy)ethylammonium, bis(2-hydroxyethyl)ammonium, benzyltrimethylammonium and benzyltriethylammonium, furthermore phosphonium ions, sulfonium ions, preferably tri(C₁-C₄-alkyl)sulfonium, and sulfoxonium ions, preferably tri(C₁-C₄-alkyl)sulfoxonium.

Anions of useful acid addition salts are primarily chloride, bromide, fluoride, hydrogen sulfate, sulfate, dihydrogen phosphate, hydrogen phosphate, phosphate, nitrate, hydrogen carbonate, carbonate, hexafluorosilicate, hexafluorophosphate, benzoate, and the anions of C₁-C₄-alkanoic acids, preferably formiate, acetate, propionate and butyrate. They can be formed by reacting the compounds of the formula IA or IB with an acid of the corresponding anion, preferably of hydrochloric acid, hydrobromic acid, sulfuric acid, phosphoric acid or nitric acid.

In particular, the substituent R^{b} takes the form of a C₁-C₈-alkyl, C₂-C₈-alkenyl, C₂-C₈-alkynyl, aryl, hetaryl, aryloxy, hetaryloxy, aryl-C₁-C₈-alkyl, hetaryl-C₁-C₈-alkyl, aryl-C₂-C₈-alkenyl, hetaryl-C₂-C₈-alkenyl, aryl-C₂-C₈-alkynyl or hetaryl-C₂-C₈-alkynyl radical which is optionally interrupted by one or more groups which are selected among O, S, SO, SO₂, NR (R═H or C₁-C₈-alkyl), CO, COO, OCO, CONH, NHCO and NHCONH, or R^{b} is a radical of the formulae defined hereinbelow CH₂ON═CR^{αR}^{β}, CH₂ON═CR^{γ}C^{δ}═NOR^{ε} or C(R^{η})═NOCH₂R^{φ}. These radicals, in particular the aryl and hetaryl moieties, optionally also have one or more (preferably 1, 2 or 3) substituents which are independently of one another selected among C₁-C₈-alkyl, C₁-C₈-alkoxy, halogen, cyano, C₁-C₈-haloalkyl (in particular CF₃ and CHF₂), hetaryl, aryl, hetaryloxy and aryloxy. The hetaryl and aryl moieties in the four last-mentioned radicals, in turn, can have 1, 2 or 3 substituents which are independently of one another selected among halogen, C₁-C₈-haloalkyl (in particular CF₃ and CHF₂), phenyl, CN, phenoxy, C₁-C₈-alkyl, C₁-C₈-alkoxy and C₁-C₈-haloalkoxy.

Such compounds are known and described for example in WO 97/10716 and in the references cited therein, which are herewith incorporated in their entirety.

Preferred strobilurins are those of the formulae IA or IB in which R^{b} is aryloxy, hetaryloxy, aryloxymethylene, hetaryloxymethylene, arylethenylene or hetarylethenylene, these radicals optionally having 1, 2 or 3 substituents which are independently of one another selected among C₁-C₈-alkyl, halogen, CF₃, CHF₂, CN, C₁-C₈-alkoxy, phenyl, phenyloxy, hetaryl and hetaryloxy, where the phenyl and the hetaryl moieties in the four last-mentioned radicals, in turn, can have 1, 2 or 3 substituents which are independently of one another selected among halogen, CF₃, CHF₂, phenyl, CN, phenoxy, C₁-C₈-alkyl, C₁-C₈-alkoxy and C₁-C₈-haloalkoxy;

or R^{b} is CH₂ON═CR^{α}R^{β} or CH₂ON═CR^{γ}CR^{δ}═NOR^{ε} or C(R^{η})═NOCH₂R^{φ},

where
R^{α} is C₁-C₈-alkyl;
R^{β} is phenyl, pyridyl or pyrimidyl, optionally having 1, 2 or 3 substituents which are independently of one another selected among C₁-C₈-alkyl, C₁-C₈-alkoxy, halogen, C₁-C₈-haloalkoxy, CF₃ and CHF₂;
R^{γ} is C₁-C₈-alkyl, C₁-C₈-alkoxy, halogen, C₁-C₈-haloalkyl or hydrogen;
R⁶⁷ is hydrogen, cyano, halogen, C₁-C₈-alkyl, C₁-C₈-alkoxy, C₁-C₈-alkylthio, C₁-C₈-alkylamino, di-C₁-C₈-alkylamino, C₂-C₈-alkenyl, C₂-C₈-alkenyloxy, C₂-C₈-alkenylthio, C₂-C₈-alkenylamino, N—C₂-C₈-alkenyl-N—C₁-C₈-alkylamino, C₂-C₈-alkynyl, C₂-C₈-alkynyloxy, C₂-C₈-alkynylthio, C₂-C₈-alkynylamino, N—C₂-C₈-alkynyl-N—C₁-C₈-alkylamino, it being possible for the hydrocarbon radicals of these groups to be partially or fully halogenated and/or to have attached to them 1, 2 or 3 radicals which are independently of one another selected among cyano, nitro, hydroxyl, C₁-C₈-alkoxy, C₁-C₈-haloalkoxy, C₁-C₈-alkoxycarbonyl, C₁-C₈-alkylthio, C₁-C₈-alkylamino, di-C₁-C₈-alkylamino, C₂-C₈-alkenyloxy, C₃-C₈-cycloalkyl, C₃-C₈-cycloalkyloxy, heterocyclyl, heterocyclyloxy, aryl, aryloxy, aryl-C₁-C₈-alkoxy, hetaryl, hetaryloxy and hetaryl-C₁-C₈-alkoxy, it being possible for the cyclic radicals, in turn, to be partially or fully halogenated and/or to have attached to them 1, 2 or 3 groups which are independently of one another selected among cyano, nitro, hydroxyl, C₁-C₈-alkyl, C₁-C₈-haloalkyl, C₃-C₈-cycloalkyl, C₁-C₈-alkoxy, C₁-C₈-haloalkoxy, C₁-C₈-alkoxycarbonyl, C₁-C₈-alkylthio, C₁-C₈-alkylamino, di-C₁-C₈-alkylamino, C₂-C₈-alkenyl and C₂-C₈-alkenyloxy;
   or
   is C₃-C₈-cycloalkyl, C₃-C₈-cycloalkyloxy, C₃-C₈-cycloalkylthio, C₃-C₈-cycloalkylamino, N—C₃-C₈-cycloalkyl-N—C₁-C₈-alkylamino, heterocyclyl, heterocyclyloxy, heterocyclylthio, heterocyclylamino, N-heterocyclyl-N—C₁-C₈-alkylamino, aryl, aryloxy, arylthio, arylamino, N-aryl-N—C₁-C₈-alkylamino, hetaryl, hetaryloxy, hetarylthio, hetarylamino or N-hetaryl-N—C₁-C₈-alkylamino, it being possible for the cyclic radicals to be partially or fully halogenated and/or to have attached to them 1, 2 or 3 groups which are independently of one another selected among cyano, nitro, hydroxyl, C₁-C₈-alkyl, C₁-C₈-haloalkyl, C₃-C₈-cycloalkyl, C₁-C₈-alkoxy, C₁-C₈-haloalkoxy, C₁-C₈-alkoxycarbonyl, C₁-C₈-alkylthio, C₁-C₈-alkylamino, di-C₁-C₈-alkylamino, C₂-C₈-alkenyl, C₂-C₈-alkenyloxy, benzyl, benzyloxy, aryl, aryloxy, hetaryl and hetaryloxy, it being possible for the aromatic radicals in turn to be partially or fully halogenated and/or to have attached to them 1, 2 or 3 of the following groups: cyano, C₁-C₈-alkyl, C₁-C₈-haloalkyl, C₁-C₈-alkoxy, nitro;
   or
   is a group CR^{κ}═NOR^{λ}, where R^{←} and R^{λ} are independently of each other C₁-C₈-alkyl;
R^{ε} is C₁-C₈-alkyl, C₂-C₈-alkenyl or C₂-C₈-alkynyl, it being possible for these groups to be partially or fully halogenated and/or to have attached to them 1, 2 or 3 of the following radicals: cyano, C₁-C₈-alkoxy, C₃-C₈-cycloalkyl;
R^{η} is H or CH₃; and
R^{φ} is H, C₁-C₄-alkyl, C₁-C₄-haloalkyl or aryl, it being possible for aryl to carry 1, 2 or 3 of the following radicals: halogen, cyano, C₁-C₄-alkyl, C₁-C₄-haloalkyl, C₁-C₄-alkoxy or C₁-C₄-haloalkoxy.

In compounds IA and IB aryl is preferably phenyl and hetaryl is preferably pyridyl, pyrimidyl, pyrrolyl, pyrazolyl, imidazolyl, oxazolyl or thiazolyl and more preferably pyridyl, pyrimidyl or pyrazolyl.

Particularly preferred compounds of the formulae IA or IB are those in which R^{b} has one of the following meanings:
a) phenyloxymethylene, pyridinyloxymethylene, pyrimidinyloxymethylene or pyrazolyloxymethylene, the aromatic radical optionally having 1, 2 or 3 substituents which are independently of one another selected among C₁-C₈-alkyl, halogen, CF₃, CHF₂,
—C(CH₃)═NOCH₃ and phenyl which is optionally substituted by 1, 2 or 3 halogen atoms and/or C₁-C₈-alkyl groups;
b) phenoxy or pyrimidinyloxy which is optionally substituted by 1, 2 or 3 halogen atoms or by a phenoxy radical which optionally has a halogen or cyano substituent;
c) phenylethenylene or pyrazolylethenylene, the phenyl or pyrazolyl radical optionally having 1, 2 or 3 substituents which are independently of one another selected among halogen, CF₃, CHF₂ and phenyl;
d) CH₂ON═CR^{α}R^{β}

in which
R^{α} is C₁-C₈-alkyl; and
R^{β} is phenyl which optionally has 1, 2 or 3 substituents which are independently of one another selected among C₁-C₈-alkyl, halogen, CF₃ and CHF₂, or is pyrimidinyl which is optionally substituted by 1 or 2 C₁-C₈-alkoxy radicals;
e) CH₂ON═CR^{γ}R⁸═NOR^{ε}, where
R^{γ} is C₁-C₈-alkyl, C₁-C₈-alkoxy or halogen;
R^{δ} is C₁-C₈-alkyl, cyano, halogen, C₁-C₈-alkoxy, C₁-C₈-alkenyl, phenyl which is optionally substituted by 1, 2 or 3 halogen atoms; or is a group CR^{κ}═NOR^{λ}, where R^{ε} and R^{λ} are independently of each other C₁-C₄-alkyl and
R^{ε} is C₁-C₈-alkyl.

Preferred compounds of the formula IA are those in which Q is phenyl and n is 0.

Among compounds IA and IB, compounds IA are preferred.

Particularly preferred strobilurins are those which are known under the common names azoxystrobin, dimoxystrobin, fluoxastrobin, kresoxim-methyl, metominostrobin, orysastrobin, picoxystrobin and trifloxystrobin, further methyl (2-chloro-5-[1-(3-methyl-benzyloxyimino)ethypenzyl)carbamate, methyl (2-chloro-5-[1-(6-methylpyridin-2-ylmethoxyimino)ethypenzyl)carbamate, methyl 2-ortho-[(2,5-dimethylphenyloxy-methylene)phenyl]-3-methoxyacrylate, and compounds of formula IA.1

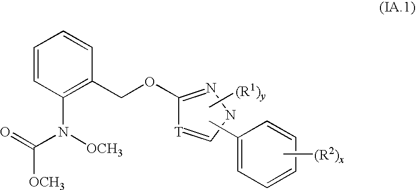

where

T is CH or N;

R¹ and R² are independently of each other halogen, C₁-C₄-alkyl or C₁-C₄-haloalkyl;

x is 0, 1 or 2; and

y is 0 or 1;

or agriculturally acceptable salts thereof.

In compounds IA.1, R¹ is preferably C₁-C₄-alkyl, in particular methyl.

R² is preferably halogen, in particular Cl, C₁-C₄-alkyl, in particular methyl, or C₁-C₄-haloalkyl, in particular CF₃.

Preferred compounds IA.1 are compiled in following table.

(IA.1)

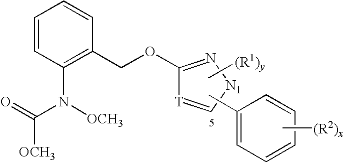

| Comp. | | | Position of the | |
|---|---|---|---|---|
| No. | T | (R¹)_{y} | group phenyl-(R^{b})ₓ | (R²)ₓ |
| I-1 | N | — | 1 | 2-F |
| I-2 | N | — | 1 | 3-F |
| I-3 | N | — | 1 | 4-F |
| I-4 | N | — | 1 | 2-Cl |
| I-5 | N | — | 1 | 3-Cl |
| I-6 | N | — | 1 | 4-Cl |
| I-7 | N | — | 1 | 2-Br |
| I-8 | N | — | 1 | 3-Br |
| I-9 | N | — | 1 | 4-Br |
| I-10 | N | — | 1 | 2-CH₃ |
| I-11 | N | — | 1 | 3-CH₃ |
| I-12 | N | — | 1 | 4-CH₃ |
| I-13 | N | — | 1 | 2-CH₂CH₃ |
| I-14 | N | — | 1 | 3-CH₂CH₃ |
| I-15 | N | — | 1 | 4-CH₂CH₃ |
| I-16 | N | — | 1 | 2-CH(CH₃)₂ |
| I-17 | N | — | 1 | 3-CH(CH₃)₂ |
| I-18 | N | — | 1 | 4-CH(CH₃)₂ |
| I-19 | N | — | 1 | 2-CF₃ |
| I-20 | N | — | 1 | 3-CF₃ |
| I-21 | N | — | 1 | 4-CF₃ |
| I-22 | N | — | 1 | 2,4-F₂ |
| I-23 | N | — | 1 | 2,4-Cl₂ |
| I-24 | N | — | 1 | 3,4-Cl₂ |
| I-25 | N | — | 1 | 2-Cl, 4-CH₃ |
| I-26 | N | — | 1 | 3-Cl, 4-CH₃ |
| I-27 | CH | — | 1 | 2-F |
| I-28 | CH | — | 1 | 3-F |
| I-29 | CH | — | 1 | 4-F |
| I-30 | CH | — | 1 | 2-Cl |
| I-31 | CH | — | 1 | 3-Cl |
| I-32 | CH | — | 1 | 4-Cl |
| I-33 | CH | — | 1 | 2-Br |
| I-34 | CH | — | 1 | 3-Br |
| I-35 | CH | — | 1 | 4-Br |
| I-36 | CH | — | 1 | 2-CH₃ |
| I-37 | CH | — | 1 | 3-CH₃ |
| I-38 | CH | — | 1 | 4-CH₃ |
| I-39 | CH | — | 1 | 2-CH₂CH₃ |
| I-40 | CH | — | 1 | 3-CH₂CH₃ |
| I-41 | CH | — | 1 | 4-CH₂CH₃ |
| I-42 | CH | — | 1 | 2-CH(CH₃)₂ |
| I-43 | CH | — | 1 | 3-CH(CH₃)₂ |
| I-44 | CH | — | 1 | 4-CH(CH₃)₂ |
| I-45 | CH | — | 1 | 2-CF₃ |
| I-46 | CH | — | 1 | 3-CF₃ |
| I-47 | CH | — | 1 | 4-CF₃ |
| I-48 | CH | — | 1 | 2,4-F₂ |
| I-49 | CH | — | 1 | 2,4-Cl₂ |
| I-50 | CH | — | 1 | 3,4-Cl₂ |
| I-51 | CH | — | 1 | 2-Cl, 4-CH₃ |
| I-52 | CH | — | 1 | 3-Cl, 4-CH₃ |
| I-53 | CH | — | 1 | — |
| I-55 | CH | 5-CH₃ | 1 | 3-CF₃ |
| I-56 | CH | 1-CH₃ | 5 | 3-CF₃ |
| I-57 | CH | 1-CH₃ | 5 | 4-Cl |
| I-58 | CH | 1-CH₃ | 5 | — |

In more preferred compounds IA.1, T is CH.

In more preferred compounds IA.1, y is 0.

In more preferred compounds, x is 0 or 1. Specifically, x is 1.

Particularly preferred compounds IA.1 are compounds I-12, I-23, I-32 and I-38. Even more preferred is compound 1-32, which is also known under the common name of pyraclostrobin.

Compounds of formula IA.1 and methods for producing them are generally known. For instance, compounds I-1 to I-55 and methods for producing them are described in WO 96/01256 and EP-A-0804421 and compounds I-56 to I-58 and their preparation are described in WO 99/33812, the contents of which are hereby fully incorporated by reference. Further compounds IA.1 can be prepared by methods analogous to those described in the above references. Compounds IA.1 are commonly known as fungicides.

Particularly preferred strobilurins are selected from compounds of formula IA.1, azoxystrobin and trifloxystrobin and even more preferably from pyraclostrobin, azoxystrobin and trifloxystrobin. Specifically, pyraclostrobin is used.

The use and the method according to the invention enhance the resistance of a plant or of a plant's seed to abiotic stress.

Abiotic stress effects can manifest themselves in various ways and can be recognized by comparing plants exposed to a specific abiotic stress factor whose seeds have been treated according to the invention with plants exposed to the same specific abiotic stress factor, but whose seeds have not been treated with the at least one strobilurin.

Naturally, the comparison must be carried out under pathogen-free conditions since otherwise the untreated plants might, as the result of infection, display symptoms which correspond to the abiotic stress effects or are similar thereto.

The abiotic stress effect manifests itself for example in that seeds which have been exposed to a specific abiotic stress factor germinate more poorly. Poorer germination means that the same number of seeds gives rise to fewer seedlings in comparison with seeds which have not been exposed to the same specific abiotic stress factor.

Alternatively, or additionally, the abiotic stress effect may manifest itself in reduced emergence. “Emergence” is understood as meaning that the seedling appears from the soil (or, in other words, that the coleoptil or the cotyledons or the shoot or the leaf break through the soil surface). Reduced emergence means that fewer seedlings appear from the soil from the same number of seeds in comparison with seeds which have not been exposed to the same specific abiotic stress factor.

In some plant species, germination and emergence may coincide, i.e. the first cotyledon already appears from the soil. However, since this is not the case with all plants, germination and emergence are described separately.

Alternatively or in addition, the abiotic stress effect can manifest itself in reduced growth of the hypocotyl, i.e. the stalk does not grow as long as expected, and, possibly, leaves and apex lie on the ground. In some plants, this characteristic is not necessarily disadvantageous since it reduces or prevents lodging; in some plant species, however, it is entirely undesirable.

Alternatively or in addition, the abiotic stress effect can manifest itself in reduced length of the plant's root. A reduced root length implies less nutrient uptake from the soil and less resistance to temperature extremes, in particular drought.

Globally, abiotic stress may manifest itself in diminished vitality of the plants (═plant vigor). Diminished vitality can be ascertained by comparison with plants whose seeds have not been exposed to the same specific abiotic stress factor. The vitality of a plant manifests itself in a variety of factors. Examples of factors which are manifestations of the plant's vitality are:
(a) overall visual appearance;
(b) root growth and/or root development;
(c) size of the leaf area;
(d) intensity of the leaves' green coloration;
(e) number of dead leaves in the vicinity of the ground;
(f) plant height;
(g) plant weight;
(h) growth rate;
(i) appearance and/or number of fruits;
(j) quality of the fruits;
(k) plant stand density;
(l) germination behavior;
(m) emergence behavior;
(n) shoot number;
(o) shoot type (quality and productivity)
(p) toughness of the plant, for example resistance to biotic or abiotic stress;
(q) presence of necroses;
(r) senescence behavior.

Accordingly, abiotic stress can manifest itself in a worsening of at least one of the abovementioned factors, for example in
(a) a poorer overall visual appearance;
(b) poorer root growth and/or poorer root development (see hereinabove);
(c) reduced size of the leaf area;
(d) less intense green coloration of the leaves;
(e) more dead leaves in the vicinity of the ground;
(f) lower plant height (“stunting” of the plant, see also hereinabove);
(g) lower plant weight;
(h) poorer growth rate;
(i) poorer appearance and/or lower number of fruits;
(j) diminished quality of the fruits;
(k) lower plant stand density;
(l) poorer germination behavior (see hereinabove);
(m) poorer emergence behavior (see hereinabove);
(n) fewer shoots;
(o) shoots in lower quality (for example weak shoots), less productive shoots
(p) reduced toughness of the plant, for example reduced resistance to biotic or abiotic stress;
(q) presence of necroses;
(r) poorer senescence behavior (earlier senescence).

Abiotic stress is triggered for example by extreme temperatures such as heat, chill, great variations in temperature, or unseasonal temperatures, drought, extreme wetness, high salinity, radiation (for example increased UV radiation as the result of the diminishing ozone layer), increased amount of ozone in the vicinity of the soil and/or organic and inorganic pollution (for example as the result of phytotoxic amounts of pesticides or contamination with heavy metals). Abiotic stress leads to a reduced quantity and/or quality of the stressed plant and its fruits. Thus, for example, the synthesis and accumulation of proteins is mainly adversely affected by temperature stress, while growth and polysaccharide synthesis are reduced by virtually all stress factors. This leads to biomass losses and to a reduced nutrient content of the plant product. Extreme temperatures, in particular cold and chill, moreover delay germination and emergence of the seedlings and reduce the plant's height and its root length. A delayed germination and emergence often implicates a generally delayed development of the plant and for example a belated ripening. A reduced root length of the plant implies less nutrient uptake from the soil and less resistance to oncoming temperature extremes, in particular drought.

In a preferred embodiment, the method of the invention serves for increasing the resistance of a plant or of a plant's seed to temperature extremes, in particular to cold temperatures (chill) and/or to great variations in temperature. Accordingly, the use according to the invention preferably is for increasing the resistance of a plant or of a plant's seed to temperature extremes, in particular to cold temperatures (chill) and/or to great variations in temperature.

Cold temperatures can for example delay the development of a plant, e.g. impede or slow down germination or blossoming or fruiting. If temperature falls below a critical value, which is generally below 0° C. (the specific critical value depending on the particular plant species or even plant variety and on the respective growth stage), cold stress leading to ice formation inside the plant tissue can even cause an irreversible physiological condition that is conductive to death or malfunction of the plant's cells. The use of strobilurins according to the invention enhances the plant's resistance to both types of negative effects of cold temperature (i.e. delayed development and dead or damaged plant tissue).

“Cold temperature” in the context of the present invention is generally understood as a temperature of at most 15° C., preferably of at most 10° C., more preferably of at most 5° C., even more preferably of at most 0° C. and particularly of at most −5° C. As a matter of course, as plants differ in their resistance to low temperature, the meaning of the term “cold temperature” also depends on the respective plant (variety) and seed from which it is to grow and on its growing stage. The skilled person is aware of the temperature below which a certain plant at a certain growth stage is damaged or impeded in its development. Just by way of example, spring wheat in the germinating stage is damaged below approximately −9° C., in the flowering stage below approximately −1° C. and in the fruiting stage below approximately −2° C.; corn in the germinating stage is damaged below approximately −2° C., in the flowering stage below approximately −1° C. and in the fruiting stage below approximately −2° C.; cotton in the germinating stage is damaged below approximately −1° C., in the flowering stage below approximately −1° C. and in the fruiting stage below approximately −2° C.; etc. Germination is delayed for most plants if temperature is below 15° C. Germination is impeded even more below 10° C. or 5° C.

In another preferred embodiment, the method of the invention serves for improving the vitality of a plant or of a plant's seed which is exposed to abiotic stress. More preferably, the method of the invention serves for improving the vitality of a plant or of a plant's seed which is exposed to cold temperature and/or extremes in temperature (=great variations in temperature).

Preferably, the plant is exposed to abiotic stress while being in the growth stage 01 to 19, more preferably 01 to 13, even more preferably 05 to 13, in particular 08 to 13, of the BBCH extended scale (German Federal Biological Research Centre for Agriculture and Forestry; see www.bba.de/veroeff/bbch/bbcheng.pdf.

In one preferred embodiment, the improved plant vigor (plant vitality) manifests itself in an improved germination. Accordingly, in a more preferred embodiment, the invention relates to a method for improving the germination of plants which or the seeds of which have been or are exposed to abiotic stress, in particular to extreme temperature, particularly to cold temperature or great temperature variations, which method comprises treating the seed from which the plant is to grow with at least one strobilurin as defined above. In another more preferred embodiment, the invention relates to the use of at least one strobilurin for improving the germination of plants which or the seeds of which have been or are exposed to abiotic stress, in particular to extreme temperature, particularly to cold temperature or great temperature variations. Improved germination means that the same number of seeds gives rise to more seedlings in comparison with seeds which have not been treated with the at least one strobilurin, the seeds or the plant growing therefrom having in each case been exposed to the same abiotic stress factor(s).

In another preferred embodiment, the improved plant vigor—additionally or alternatively—manifests itself in an improved emergence. Accordingly, in a more preferred embodiment, the invention relates to a method for improving the emergence of plants which or the seeds of which have been or are exposed to abiotic stress, in particular to extreme temperature, particularly to cold temperature or great temperature variations, which method comprises treating the seed from which the plant is to grow with at least one strobilurin as defined above. In another more preferred embodiment, the invention relates to the use of at least one strobilurin for improving the emergence of plants which or the seeds of which have been or are exposed to abiotic stress, in particular to extreme temperature, particularly to cold temperature or great temperature variations. Improved emergence means that more seedlings appear from the soil from the same number of seeds in comparison with seeds which have not been treated with the at least one strobilurin, the seeds or the plant growing therefrom having in each case been exposed to the same abiotic stress factor(s).

In another preferred embodiment, the improved plant vigor—additionally or alternatively—manifests itself in a reduced stunting, or, in other words, in an increased plant height. Accordingly, in a more preferred embodiment, the invention relates to a method for increasing the plant height of plants which or the seeds of which have been or are exposed to abiotic stress, in particular to extreme temperature, particularly to cold temperature or great temperature variations, which method comprises treating the seed from which the plant is to grow with at least one strobilurin as defined above. In another more preferred embodiment, the invention relates to the use of at least one strobilurin for increasing the height of plants which or the seeds of which have been or are exposed to abiotic stress, in particular to extreme temperature, particularly to cold temperature or great temperature variations. Reduced stunting or increased plant height means that the hypocotyl, i.e. the stalk, is at the same point of time higher than the stalk of plants which or the seeds of which have been exposed to the same abiotic stress factor(s), but which have not been treated with the at least one strobilurin.

In another preferred embodiment, the improved plant vigor—additionally or alternatively—manifests itself in an increased root length. Accordingly, in a more preferred embodiment, the invention relates to a method for increasing the root length of plants which or the seeds of which have been or are exposed to abiotic stress, in particular to extreme temperature, particularly to cold temperature or great temperature variations, which method comprises treating the seed from which the plant is to grow with at least one strobilurin as defined above. In another more preferred embodiment, the invention relates to the use of at least one strobilurin for increasing the root length of plants which or the seeds of which have been or are exposed to abiotic stress, in particular to extreme temperature, particularly to cold temperature or great temperature variations.

Increased root length means that the root is at the same point of time longer than the root of plants which or the seeds of which have been exposed to the same abiotic stress factor(s), but which have not been treated with the at least one strobilurin.

In particular, the invention relates to a method for improving the plant vigor, in particular for improving the germination and/or the emergence and/or for increasing the plant height and/or for increasing the root length of plants which or the seeds of which have been or are exposed to abiotic stress, in particular to extreme temperature, particularly to cold temperature or great temperature variations, which method comprises treating the seed from which the plant is to grow with at least one strobilurin as defined above. The invention also relates in particular to the use of at least one strobilurin as defined abovefor improving the plant vigor, in particular for improving the germination and/or the emergence and/or for increasing the plant height and/or for increasing the root length of plants which or the seeds of which have been or are exposed to abiotic stress, in particular to extreme temperature, particularly to cold temperature or great temperature variations.

Preferably, the plants to which the invention is related are agriculturally useful plants or else ornamentals. Agriculturally useful plants are crop plants where parts or the entire plant act as a raw material for foodstuffs, feeding stuffs, fibers (for example cotton, linen), fuels (for example timber, bioethanol, biodiesel, biomass) or other chemical compounds. Examples are cereals such as wheat (inclusive spelt, einkorn, emmer, kamut, durum and triticale), rye, barley, oats, rice, wild rice, maize (corn), millet, sorghum and teff, pseudocereals such as amaranth, quinoa and buckwheat, legumes of agricultural use such as bean, vegetable pea, fodder pea, chickpea, lentil, soybean and peanut, oilseed rape (canola), sunflower, cotton, sugar beet, stone fruit, pome fruit, citrus fruit, banana, strawberry, blueberry, almond, grape, mango, pawpaw, potato, tomato, capsicum (pepper), cucumber, pumpkin/squash, melon, watermelon, garlic, onion, carrot, cabbage, lucerne, clover, flax, elephant grass (Miscanthus), grass, lettuce, sugar cane, tea, tobacco and coffee.

Preferred agriculturally useful plants are selected from the above cereals, legumes, sunflower, sugar cane, sugar beet, oilseed rape (canola) and cotton, more preferably from soybean, maize (corn), wheat, triticale, oats, rye, barley, oilseed rape, millet, sorghum, rice, sunflower, sugar cane, sugar beet and cotton, and even more preferably from soybean, wheat, maize (corn), oilseed rape (canola), sugar beet and cotton.

Alternatively, preferred agriculturally useful plants are selected among potato, tomato, capsicum (pepper), cucumber, pumpkin/squash, melon, watermelon, garlic, onion, carrot, cabbage, bean, vegetable pea, fodder pea and lettuce, more preferably among tomato, onion, lettuce and pea.

Examples of ornamentals are turf, geranium, pelargonium, petunia, begonia and fuchsia, to mention only a few examples of a large number of ornamentals.

The plants can be non-transgenic or transgenic in nature.

In one embodiment of the invention, if the plant is transgenic, it is preferred that the recombinant modification of the transgenic plant is such in nature that the plant has resistance to a certain pesticide. For example, the transgenic plant can have a resistance to the herbicide glyphosate. Examples of transgenic plants are those with a resistance to herbicides from the group of the sulfonylurea (see, for example, EP-A-0257993, U.S. Pat. No. 5,013,659), the imidazolinones (see, for example, U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073), of the glyfosinate type (see, for example, EP-A-0242236, EP-A-242246) or of the glyphosate type (see, for example, WO 92/00377) or plants with resistance to herbicides from the group of the cyclohexadienones/aryloxyphenoxypropionic acid herbicides (see, for example, U.S. Pat. No. 5,162,602, U.S. Pat. No. 5,290,696, U.S. Pat. No. 5,498,544, U.S. Pat. No. 5,428,001, U.S. Pat. No. 6,069,298, U.S. Pat. No. 6,268,550, U.S. Pat. No. 6,146,867, U.S. Pat. No. 6,222,099, U.S. Pat. No. 6,414,222) or transgenic plants such as cotton which are capable of forming Bacillus thuringiensis toxins (Bt toxins) which may make them resistant to certain pests (see, for example, EP-A-0142924, EP-A-0193259).

It is to be understood, however, that when the plant is a transgenic plant, the transgenic events that are present in the plant are by no means limited to those that provide pesticide resistance, but can include any transgenic event. In fact, the use of “stacked” transgenic events in a plant is also contemplated.

As regards the manner and the amount in which the above-described strobilurins are used, reference is made to what is said hereinbelow in connection with the method according to the invention.

The treatment of the plants' seed can be accomplished for example in such a way that the seed is treated with one strobilurin or with at least two different strobilurins. If more than one strobilurin is used the different compounds can be used as a mixture. Alternatively, the seed can be treated with the at least two strobilurins in separate form, it being possible for the treatment with the individual active substances to be accomplished simultaneously or in succession. In the case of successive treatment, the time interval may be from a few seconds up to several months, for example up to 6, 8 or even 10 months. However, the time interval must be such that the desired effect can take place. Preferably, the interval between the treatments is relatively short, i.e. the different strobilurins are applied within a time interval of from a few seconds up to at most one month, especially preferably up to not more than one week and in particular up to not more than one day.

The seed may be treated according to the invention before sowing or else via the growth substrate into which it is sown, for example during sowing in the form of what is known as the in-furrow application. In this form of application, the plant protectant is placed into the furrow essentially at the same time as the seed.

Preferably, the seed is treated before sowing. In principle, all customary methods of treating and in particular dressing such as coating (e.g. pelleting) and imbibing (e.g.

soaking) seeds can be employed. Specifically, the seed treatment follows a procedure in which the seed is exposed to the specifically desired amount of a preparation comprising the active compounds used according to the invention (=at least one strobilurin). The preparation may be a formulation that is applied as such or after previously diluting it, e.g. with water; for instance, it may be expedient to dilute seed treatment formulations 2-10 fold leading to concentrations in the ready-to-use compositions of 0.01 to 60% by weight active compound by weight, preferably 0.1 to 40% by weight.

Usually, a device which is suitable for this purpose, for example a mixer for solid or solid/liquid components, is employed until the preparation is distributed uniformly on the seed. Thus, the preparation can be applied to seeds by any standard seed treatment methodology, including but not limited to mixing in a container (e.g., a bottle, bag or tumbler), mechanical application, tumbling, spraying, and immersion. If appropriate, this is followed by drying.

Particular embodiments of the present invention comprise seed coating and imbibition (e.g. soaking). “Coating” denotes any process that endows the outer surfaces of the seeds partially or completely with a layer or layers of non-plant material, and “imbibition” any process that results in penetration of the active ingredient(s) into the germinable parts of the seed and/or its natural sheath, (inner) husk, hull, shell, pod and/or integument. The invention therefore also relates to a treatment of seeds which comprises providing seeds with a coating that comprises the active compounds used according to the invention, and to a treatment of seeds which comprises imbibition of seeds with the active compounds used according to the invention.

Coating is particularly effective in accommodating high loads of the active compounds, as may be required to treat typically refractory fungal pathogens, while at the same time excessive phytotoxicity is avoided.

Coating may be applied to the seeds using conventional coating techniques and machines, such as fluidized bed techniques, the roller mill method, rotostatic seed treaters, and drum coaters. Other methods such as the spouted beds technique may also be useful. The seeds may be pre-sized before coating. After coating, the seeds are typically dried and then transferred to a sizing machine for sizing.

Such procedures are known in the art. Seed coating methods and apparatus for their application are disclosed in, for example, U.S. Pat. No. 5,918,413, U.S. Pat. No. 5,891,246, U.S. Pat. No. 5,554,445, U.S. Pat. No. 5,389,399, U.S. Pat. No. 5,107,787, U.S. Pat. No. 5,080,925, U.S. Pat. No. 4,759,945 and U.S. Pat. No. 4,465,017.

In another particular embodiment, the active compounds used according to the invention can be mixed directly with seeds, for instance as a solid fine particulate formulation, e.g. a powder or dust. Optionally, a sticking agent can be used to support the adhesion of the solid, e.g. the powder, to the seed surface. For example, a quantity of seed can be mixed with a sticking agent (which increases adhesion of the particles on the surface of the seed) and optionally agitated to encourage uniform coating of the seed with the sticking agent. For example, the seed can be mixed with a sufficient amount of sticking agent, which leads to a partial or complete coating of the seed with sticking agent. The seed pretreated in this way is then mixed with a solid formulation containing the active compounds used according to the invention to achieve adhesion of the solid formulation on the surface of the seed material. The mixture can be agitated, for example by tumbling, to encourage contact of the sticking agent with the solid formulation of active compounds used according to the invention, thereby causing the active compounds used according to the invention to stick to the seed.

Another particular method of treating seed with the active compounds used according to the invention is imbibition. For example, seed can be combined for a period of time with an aqueous solution comprising from about 1% by weight to about 75% by weight of the active compounds in a solvent such as water. Preferably the concentration of the solution is from about 5% by weight to about 50% by weight, more preferably from about 10% by weight to about 25% by weight. During the period in which the seed is combined with the solution, the seed takes up (imbibes) at least a portion of the active compounds. Optionally, the mixture of seed and solution can be agitated, for example by shaking, rolling, tumbling, or other means. After the imbibition process, the seed can be separated from the solution and optionally dried in a suitable manner, for example by patting or air-drying.

In yet another particular embodiment of the present invention, the active compounds used according to the invention can be introduced onto or into a seed by use of solid matrix priming. For example, a quantity of the active compounds can be mixed with a solid matrix material, and then the seed can be placed into contact with the solid matrix material for a period to allow the active compounds to be introduced to the seed. The seed can then optionally be separated from the solid matrix material and stored or used, or, preferably, the mixture of solid matrix material plus seed can be stored or planted/sown directly.

The active substances can be formulated, in the ready-to-use preparations, in suspended, emulsified or dissolved form, either jointly or separately. The use forms depend entirely on the intended purposes.

The active substances can be employed as such, in the form of their formulations or the use forms prepared therefrom, for example in the form of directly sprayable solutions, powders, suspensions or dispersions, also highly concentrated aqueous, oily or other suspensions or dispersions, emulsions, oil dispersions, pastes, dusts, tracking powders or granules. The application is usually accomplished by spraying, misting, atomizing, scattering or pouring. The use forms and use methods depend on the intended purposes; in any case, they should ensure the finest possible distribution of the active substances.

Depending on the presentation in which the ready-to-use preparations of the active substances are present, they comprise one or more liquid or solid carriers, optionally surface-active substances and optionally further adjuvants which are conventionally used for the formulation of plant protectants. The compositions for such formulations are well known to the skilled worker.

Aqueous use forms can be prepared for example starting from emulsion concentrates, suspensions, pastes, wettable powders or water-dispersible granules by adding water. To prepare emulsions, pastes or oil dispersions, the active substances, as such or dissolved in an oil or solvent, can be homogenized in water by means of wetter, adhesive, dispersant or emulsifier. However, it is also possible to prepare concentrates consisting of active substance, wetter, adhesive, dispersant or emulsifier and, if appropriate, solvent or oil, and such concentrates are suitable for dilution with water.

The concentrations of the active substances in the ready-to-use preparations can be varied within substantial ranges. In general, they are between 0.0001 and 10%, preferably between 0.01 and 1% (% by weight total active substance content based on the total weight of the ready-to-use preparation).

The active substances can also be employed successfully in the ultra-low-volume method (ULV), it being possible to apply formulations with more than 95% by weight of active substance, or indeed the active substances without additives.

It is possible to add, to the active substances, oils of various types, wetters, adjuvants, herbicides, fungicides which are other than the fungicides employed in accordance with the invention, insecticides, nematicides, other pesticides such as bactericides, algicides, molluscicides, rodenticides, and bird/mammal repellents, safeners, fertilizers and/or growth regulators, if appropriate only just before use (tank mix). These can be admixed to the active substances employed in accordance with the invention in a weight ratio of 1:100 to 100:1, preferably 1:10 to 10:1.

Adjuvants within this meaning are, in particular, organic modified polysiloxanes, for example Break Thru S 240®; alcohol alkoxylates, for example Atplus 245®, Atplus MBA 1303®, Plurafac LF 300® and Lutensol ON 30®; EO/PO block polymers, for example Pluronic RPE 2035® and Genapol B®; alcohol ethoxylates, for example Lutensol XP 80®; and sodium dioctyl sulfosuccinate, for example Leophen RA®.

To widen the spectrum of action, the active ingredients can also be employed together with other active ingredients which are useful in seed treatment, for example together with fungicides, insecticides, molluscicides, nematicides, herbicides, algicides, bactericides, rodenticides, bird/mammal repellents, growth regulators, safeners or also fertilizers.

The following list of active ingredients with which the active ingredients can be used in accordance with the invention is intended to illustrate the possible combinations, but not to impose any limitation:

Fungicides:
(1.1) amine derivatives such as guazatine;
(1.2) anilinopyrimidines such as pyrimethanil, mepanipyrim and cyprodinil;
(1.3) azole fungicides such as bitertanol, bromoconazole, cyproconazole, difenoconazole, dinitroconazole, epoxiconazole, fenbuconazole, fluquiconazole, flusilazole, hexaconazole, imazalil, metconazole, myclobutanil, penconazole, propiconazole, prochloraz, prothioconazole, tebuconazole, triadimefon, triadimenol, triflumizol, triticonazole, flutriafol;
(1.4) dicarboximides such as iprodione, procymidone, vinclozolin;
(1.5) dithiocarbamates such as mancozeb, metiram and thiram;
(1.6) heterocylic compounds such as benomyl, carbendazim, fuberidazole, picobenzamid, penthiopyrad, proquinazid, thiabendazole and thiophanate-methyl;
(1.7) phenylpyrroles such as fenpiclonil and fludioxonil;
(1.8) other fungicides, for example benthiavalicarb, cyflufenamid, fosetyl, fosetyl-aluminium, phosphorous acid and its salts, iprovalicarb and metafenone;
(1.9) cinnamides and analogous compounds such as dimethomorph, flumetover and flumorph;

Insecticides/Acaricides:
(2.1) organo(thio)phosphates selected from acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos and trichlorfon;
(2.2) carbamates selected from alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb and triazamate;
(2.3) pyrethroids selected from allethrin, bifenthrin, cycloprothrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, flucythrinate, imiprothrin, lambda-cyhalothrin, gamma-cyhalothrin, permethrin, prallethrin, pyrethrin I and II, resmethrin, silafluofen, tau-fluvalinate, tefluthrin, tetramethrin, tralomethrin, transfluthrin and profluthrin, dimefluthrin;
(2.4) growth regulators selected from a) chitin synthesis inhibitors that are selected from the benzoylureas bistrifluron, chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole and clofentazine; b) ecdysone antagonists that are selceted from halofenozide, methoxyfenozide, tebufenozide and azadirachtin; c) juvenoids that are selected from pyriproxyfen, methoprene and fenoxycarb and d) lipid biosynthesis inhibitors that are selected from spirodiclofen, spiromesifen and spirotetramat;
(2.5) nicotinic receptor agonist/antagonist compounds selected from clothianidin, dinotefuran, imidacloprid, thiamethoxam, nitenpyram, acetamiprid, thiacloprid;
(2.6) GABA antagonist compounds selected from acetoprole, endosulfan, ethiprole, fipronil, vaniliprole,
(2.7) macrocyclic lactone insecticides selected from abamectin, emamectin, milbemectin, lepimectin and spirosad;
(2.8) METI I compounds selected from fenazaquin, pyridaben, tebufenpyrad, tolfenpyrad and flufenerim;
(2.9) METI II and III compounds selected from acequinocyl, fluacyprim and hydramethylnon;
(2.10) uncoupler compounds: chlorfenapyr;
(2.11) oxidative phosphorylation inhibitor compounds selected from cyhexatin, diafenthiuron, fenbutatin oxide and propargite;
(2.12) moulting disruptor compounds: cyromazine;
(2.13) mixed function oxidaes inhibitor compounds: piperonyl butoxide;
(2.14) sodium channel blocker compounds selected from metaflumizone and indoxacarb;
(2.15) a compound selected from benclothiaz, bifenazate, cartap, flonicamid, pyridalyl, pymetrozine, sulfur, thiocyclam, flubendiamide, cyenopyrafen, flupyrazofos, cyflumetofen, amidoflumet, the aminoisothiazole compound of formula Γ¹

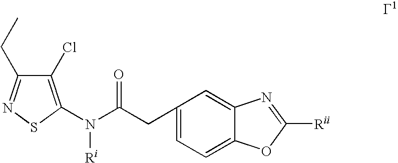

wherein Rⁱ is —CH₂OCH₂CH₃ or H and Rⁱⁱ is CF₂CF₂CF₃ or CH₂C(CH₃)₃; anthranilamide compounds of formula Γ²

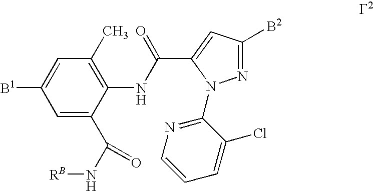

wherein B¹ is hydrogen, CN or Cl, B² is Br or CF₃, and R^{B} is hydrogen, CH₃ or CH(CH₃)₂;
and malonitrile compounds as described in JP 2002-284608, WO 02/89579, WO 02/90320, WO 02/90321, WO 04/06677, WO 04/20399 or JP 2004-99597.
Molluscicides;
Nematicides;
Herbicides, for example imidazolinone herbicides such as imazethapyr, imazamox, imazapyr and imazapic, or dimethenamid-p;
Algicides;
Bactericides;
Biologicals;
Bird/mammal repellents;
Fertilizers;
Fumigants;
Growth regulators;
Rodenticides.

Molluscicides, nematicides, herbicides, algicides, bactericides, biologicals, bird/mammal repellents, fertilizers, fumigants, growth regulators and rodenticides are well known to a person skilled in the art.

Preferred insecticides are selected from acetamiprid, alpha-cypermethrin, beta-cypermethrin, bifenthrin, carbofuran, carbosulfan, clothianidin, cycloprothrin, cyfluthrin, cypermethrin, deltamethrin, diflubenzuron, dinotefuran, etofenprox, fenbutatin-oxide, fenpropathrin, fipronil, flucythrinate, imidacloprid, lambda-cyhalothrin, nitenpyram, pheromones, spinosad, teflubenzuron, tefluthrin, terbufos, thiacloprid, thiamethoxam, thiodicarb, tralomethrin, triazamate, zeta-cypermethrin, spirotetramat, flupyrazofos, tolfenpyrad, flubendiamide, bistrifluron, benclothiaz, pyrafluprole, pyriprole, amidoflumet, flufenerim, cyflumetofen, cyenopyrafen, the anthranilamide compound of formula Γ² where B¹ is Cl, B² is Br and R^{B} is CH₃, and the anthranilamide compound of formula Γ² where B¹ is CN, B² is Br and R^{B} is CH₃.

More preferred insecticides are GABA antagonist compounds, herein preferred being fipronil, and nicotinic receptor agonist/antagonist compounds, herein preferred being clothianidin, imidacloprid and thiamethoxam. A particularly preferred insecticide is fipronil.

In a specific embodiment of the invention, no further fungicides and are employed in addition to the strobilurins employed in accordance with the invention. In a more specific embodiment, no further active compounds except the at least one strobilurin are employed in the method of the invention.

The formulations containing the active ingredients according to the invention are prepared in a known manner, e.g. by extending the active substances with solvents and/or carriers, if desired using surface-active substances, i.e. emulsifiers and dispersants. Solvents/auxiliaries which are suitable are essentially:
water, aromatic solvents (for example Solvesso products, xylene), paraffins (for example mineral fractions), alcohols (for example methanol, butanol, pentanol, benzyl alcohol), ketones (for example cyclohexanone, methyl hydroxybutyl ketone, diacetone alcohol, mesityl oxide, isophorone), lactones (for example gamma-butyrolacton), pyrrolidones (pyrrolidone, N-methylpyrrolidone, N-ethylpyrrolidone, n-octylpyrrolidone), acetates (glycol diacetate), glycols, fatty acid dimethylamides, fatty acids and fatty acid esters. In principle, solvent mixtures may also be used.
carriers such as ground natural minerals (e.g. kaolins, clays, talc, chalk) and ground synthetic minerals (e.g. highly disperse silica, silicates); emulsifiers such as nonionic and anionic emulsifiers (e.g. polyoxyethylene fatty alcohol ethers, alkylsulfonates and arylsulfonates) and dispersants such as lignin-sulfite waste liquors and methylcellulose.

Surface active compounds are all those surfactants which are suitable for formulating agrochemical actives, in particular for the active ingredients used according to the present invention, and which may be nonionic, cationic, anionic or amphoteric. According to their action, surfactants—sometimes referred to as “additives”—may be divided into wetters, dispersants, emulsifiers or protective colloids; however, these particular groups may overlap and cannot be divided strictly.

Suitable wetters are all those substances which promote wetting and which are conventionally used for formulating agrochemical active ingredients. Alkylnaphthalenesulfonates such as diisopropyl- or diisobutylnaphthalenesulfonates can be used preferably.

Dispersants and/or emulsifiers which are suitable are all nonionic, anionic and cationic dispersants or emulsifiers conventionally used for formulating agrochemical active ingredients. The following can preferably be used: nonionic or anionic dispersants and/or emulsifiers or mixtures of nonionic or anionic dispersants and/or emulsifiers.

Suitable nonionic dispersants and/or emulsifiers which may be employed are, in particular, ethylene oxide/alkylene oxide block copolymers, alkylphenol polyglycol ethers and tristyrylphenol polyglycol ethers, for example polyoxyethylene octylphenol ether, ethoxylated isooctylphenol, octylphenol, nonylphenol, alkylphenol polyglycol ether, tributylphenyl polyglycol ether, tristearylphenyl polyglycol ether, alkylarylpolyether alcohols, alcohol and fatty alcohol ethylene oxide condensates, ethoxylated castor oil, polyoxyethylene alkyl ether, ethoxylated polyoxypropylene, lauryl alcohol polyglycol ether acetal, sorbitol esters and methyl cellulose.

Suitable anionic dispersants which and/or emulsifiers which may be employed are, in particular, alkali metal, alkaline earth metal and ammonium salts of ligninsulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore arylsulfonate/formaldehyde condensates, for example condensates of sulfonated naphthalene and naphthalene derivatives with formaldehyde, condensates of naphthalene or of naphthalenesulfonic acid with phenol and formaldehyde, ligninsulfonates, lignin-sulfite waste liquors, phosphated or sulfated derivatives of methylcellulose, and salts of polyacrylic acid.

Protective colloids are typically water soluble, amphiphilic polymers. Examples include proteins and denatured proteins such as casein, polysaccharides such as water soluble starch derivatives and cellulose derivatives, in particular hydrophobic modified starch and celluloses, furthermore polycarboxylates such as polyacrylic acid and acrylic acid copolymers, polyvinylalcohol, polyvinylpyrrolidone, vinylpyrrolidone copolymers, polyvinyl amines, polyethylene imines and polyalkylene ethers.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, mesityl oxide, isophorone, strongly polar solvents, for example dimethyl sulfoxide, 2-pyrrolidone, N-methylpyrrolidone, butyrolactone and water.

Powders, materials for spreading and dusts can be prepared by mixing or concomitantly grinding the active substances with a solid carrier.

Granules, for example coated granules, impregnated granules and homogeneous granules, can be prepared by binding the active ingredients to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

Formulations for the treatment of seed may additionally comprise binders and/or gelling agents and, if appropriate, colorants.

In general, the formulations comprise from 0.01 to 95% by weight, preferably from 0.1 to 90% by weight, in particular from 5 to 50% by weight, of the active substance. The active substances are employed in a purity of from 90% to 100%, preferably 95% to 100% (according to NMR spectrum).

For the treatment of seed, the relevant formulations will, after having been diluted by a factor of two to ten, give active substance concentrations of from 0.01 to 60% by weight, preferably 0.1 to 40% by weight, in the ready-to-use preparations.

The following are examples of formulations:

1. Products for Dilution with Water

I) Water-Soluble Concentrates (SL, LS)

10 parts by weight of active substance are dissolved in 90 parts by weight of water or a water-soluble solvent. As an alternative, wetters or other adjuvants are added. The active substance dissolves upon dilution with water. This gives a formulation with an active substance content of 10% by weight.

II) Dispersible Concentrates (DC)

20 parts by weight of active substance are dissolved in 70 parts by weight of cyclohexanone with addition of 10 parts by weight of a dispersant, for example polyvinylpyrrolidone. The active substance content is 20% by weight. Dilution with water gives a dispersion.

III) Emulsifiable Concentrate (EC)

15 parts by weight of active substance are dissolved in 75 parts by weight of xylene with addition of calcium dodecylbenzenesulfonate and castor oil ethoxylate (in each case 5 parts by weight). The formulation has an active substance content of 15% by weight. Dilution with water gives an emulsion.

IV) Emulsions (EW, EO, ES)

25 parts by weight of active substance are dissolved in 35 parts by weight of xylene with addition of calcium dodecylbenzenesulfonate and castor oil ethoxylate (in each case 5 parts by weight). This mixture is introduced into 30 parts by weight of water by means of an emulsifier (Ultraturrax) and made into a homogeneous emulsion. The formulation has an active substance content of 25% by weight.

V) Suspensions (SC, OD, FS)

In an agitated ball mill, 20 parts by weight of active substance are comminuted with addition of 10 parts by weight of dispersants and wetters and 70 parts by weight of water or an organic solvent to give a fine active substance suspension. The active substance content in the formulation is 20% by weight. Dilution with water gives a stable suspension of the active substance.

VI) Water-Dispersible Granules and Water-Soluble Granules (WG, SG)

50 parts by weight of active substance are ground finely with addition of 50 parts by weight of dispersants and wetters and made into water-dispersible or water-soluble granules by means of technical appliances (for example extrusion, spray tower, fluidized bed). The formulation has an active substance content of 50% by weight. Dilution with water gives a stable dispersion or solution of the active substance.

VII) Water-Dispersible Powders and Water-Soluble Powders (WP, SP, SS, WS)

75 parts by weight of active substance are ground in a rotor-stator mill with addition of 25 parts by weight of dispersants, wetters and silica gel. The active substance content of the formulation is 75% by weight. Dilution with water gives a stable dispersion or solution of the active substance.

VIII) Gel Formulations (GF)

In a ball mill, 20 parts by weight of active substance, 10 parts by weight of dispersant, 1 part by weight of gelling agent and 70 parts by weight of water or of an organic solvent are mixed to give a fine suspension.

2. Products to be Applied Undiluted

IX) Dusts (DP, DS)

5 parts by weight of active substance are ground finely and mixed intimately with 95 parts by weight of finely divided kaolin. This gives a tracking powder with an active substance content of 5% by weight.

X) Granules (GR, FG, GG, MG)

0.5 parts by weight of active substance are ground finely and associated with 95.5 parts by weight of carriers. Current methods here are extrusion, spray-drying or the fluidized bed. This gives granules to be applied undiluted with an active substance content of 0.5% by weight.

XI) ULV Solutions (UL)

10 parts by weight of active substance are dissolved in 90 parts by weight of an organic solvent, for example xylene. This gives a product to be applied undiluted with an active substance content of 10% by weight.

Suitable formulations for the treatment of seeds are, for example:
I water-soluble concentrates (LS)
III emulsifiable concentrates (EC)
IV emulsions (ES)
V suspensions (FS)
VI water-dispersible granules and water-soluble granules (SG)
VII water-dispersible powders and water-soluble powders (WS, SS)
VIII gel formulations (GF)
IX dusts and dust-like powders (DS)

For the treatment of seed, powders, such as water-dispersible, water-soluble and dustable powders, dusts and suspensions are preferred. Further, gel formulations are preferred. Also, water-soluble concentrates and emulsions may be expediently used.

The following formulations are particularly preferred for seed treatment: flowable concentrates (especially FS); solutions (especially LS); powders for dry treatment (especially DS); water dispersible powders for slurry treatment (especially WS); water-soluble powders (especially SS) and emulsions (especially ES). Also preferred are gel formulations (especially GF). These formulations can be applied to the seed diluted or undiluted.

It is even more preferred to use FS formulations. Usually, such formulations comprise from 1 to 800 g/l active substances, 1 to 200 g/l surfactants, 0 to 200 g/l antifreeze agent, 0 to 400 g/l binder, 0 to 200 g/l colorants and solvents, preferably water.

Preferred FS formulations of the active substances for the treatment of seed usually comprise 0.5 to 80% active substance, 0.05 to 5% wetter, 0.5 to 15% dispersant, 0.1 to 5% thickener, 5 to 20% antifreeze agent, 0.1 to 2% antifoam, 1 to 20% pigment and/or colorants, 0 to 15% adhesive or sticker, 0 to 75% filler/vehicle and 0.01 to 1% preservative.

In general, a seed treatment formulation preferably comprises at least one auxiliary agent that is specifically suited for the seed treatment, i.e. an auxiliary agent which in particular promotes adhesion of the active ingredients to and/or penetration into the seeds and/or otherwise improves stability and/or manageability of the composition or the seeds treated therewith.

In particular, seed treatment auxiliary agents are selected from the group consisting of agents suitable for seed coating materials, agents suitable for solid matrix priming materials, penetration enhancers suitable for promoting seed imbibition, colorants, antifreezes, and gelling agents.

According to a preferred embodiment, the seed coating material comprises a binder (or sticker). Optionally, the coating material also comprises one or more additional seed treatment auxiliary agents selected from the group consisting of fillers and plasticizers.

Binders (or stickers) are all customary binders (or stickers) which can be employed in seed treatment formulations. Binders (or stickers) that are useful in the present invention preferably comprise an adhesive polymer that may be natural or partly or wholly synthetic and is without phytotoxic effect on the seed to be coated. Preferably, the binder (or sticker) is biodegradable. Preferably the binder or sticker is chosen to act as a matrix for active compound.

The binder (or sticker) may be selected from polyesters, polyether esters, polyanhydrides, polyester urethanes, polyester amides; polyvinyl acetates; polyvinyl acetate copolymers; polyvinyl alcohols and tylose; polyvinyl alcohol copolymers; polyvinylpyrolidones; polysaccharides, including starches, modified starches and starch derivatives, dextrins, maltodextrins, alginates, chitosanes and celluloses, cellulose esters, cellulose ethers and cellulose ether esters including ethylcelluloses, methylcelluloses, hydroxymethylcelluloses, hydroxypropylcelluloses and carboxymethylcellulose; fats; oils; proteins, including casein, gelatin and zeins; gum arabics; shellacs; vinylidene chloride and vinylidene chloride copolymers; lignosulfonates, in particular calcium lignosulfonates; polyacrylates, polymethacrylates and acrylic copolymers; polyvinylacrylates; polyethylene oxide; polybutenes, polyisobutenes, polystyrene, polyethyleneamines, polyethylenamides; acrylamide polymers and copolymers; polyhydroxyethyl acrylate, methylacrylamide monomers; and polychloroprene. In a particular embodiment, the binder is a thermoplastic polymer.

In a particular embodiment of the invention the seed treatment formulation contains at least one polyester, which, in particular, is selected from polylactides, partially aromatic polyesters (copolymers of terephthalic acid, adipic acid and aliphatic diols), polyglycolides, polyhydroxyalkanoates and polytartrates.

The amount of binder (or sticker) in the formulation can vary, but will be in the range of about 0.01 to about 25% of the total weight, more preferably from about 1 to about 15%, and even more preferably from about 5% to about 10%.

As mentioned above, the coating material can optionally also comprise a filler. The filler can be an absorbent or an inert filler, such as are known in the art, and may include wood flours, cereal flours, tree bark mill, wood meal and nut shell meal, sugars, in particular polysaccharides, activated carbon, fine-grain inorganic solids, silica gels, silicates, clays, chalk, diatomaceous earth, calcium carbonate, magnesium carbonate, dolomite, magnesium oxide, calcium sulfate and the like. Clays and inorganic solids which may be used include calcium bentonite, kaolin, china clay, talc, perlite, mica, vermiculite, silicates, quartz powder, montmorillonite, attapulgite, bole, loess, limestone, lime and mixtures thereof. Sugars which may be useful include dextrin and maltodextrin. Cereal flours include wheat flour, oat flour and barley flour. The filler may also comprise fertilizer substances such as, for example, ammonium sulfate, ammonium phosphate, ammonium nitrate, ureas and mixtures thereof.

The filler is selected so that it will provide a proper microclimate for the seed, for example the filler is used to increase the loading rate of the active ingredients and to adjust the control-release of the active ingredients. The filler can aid in the production or process of coating the seed. The amount of filler can vary, but generally the weight of the filler components will be in the range of about 0.05 to about 75% of the total weight, more preferably about 0.1 to about 50%, and even more preferably about 0.5% to 15%.

It is preferred that the binder (or sticker) be selected so that it can serve as a matrix for the active ingredients. While the binders disclosed above may all be useful as a matrix, it is preferred that a continuous solid phase of one or more binder compounds is formed throughout which is distributed as a discontinuous phase the active ingredients. Optionally, a filler and/or other components can also be present in the matrix. The term “matrix” is to be understood to include what may be viewed as a matrix system, a reservoir system or a microencapsulated system. In general, a matrix system consists of the active ingredients and a filler uniformly dispersed within a polymer, while a reservoir system consists of a separate phase comprising the active ingredients or salts thereof that are physically dispersed within a surrounding, rate-limiting, polymeric phase. Microencapsulation includes the coating of small particles or droplets of liquid, but also to dispersions in a solid matrix.

Especially if the active ingredients used in the coating have an oily type composition and little or no inert filler is present, it may be useful to hasten the drying process by drying the composition. This optional step may be accomplished by means well known in the art and can include the addition of calcium carbonate, kaolin or bentonite clay, perlite, diatomaceous earth, or any absorbent material that is added preferably concurrently with the active ingredients coating layer to absorb the oil or excess moisture. The amount of absorbent necessary to effectively provide a dry coating will be in the range of about 0.5 to about 10% of the weight of the seed.

Optionally, the coating material comprises a plasticizer. Plasticizers are typically used to make the film that is formed by the coating layer more flexible, to improve adhesion and spreadability, and to improve the speed of processing. Improved film flexibility is important to minimize chipping, breakage or flaking during storage, handling or sowing processes. Many plasticizers may be used; however, useful plasticizers include polyethylene glycol, oligomeric polyalkylene glycols, glycerol, alkylbenzylphthalates, in particular butylbenzylphthalate, glycol benzoates and related compounds. The amount of plasticizer in the coating layer will be in the range of from about 0.1% by weight to about 20% by weight.

Agents suitable for solid matrix priming materials which are useful in the present invention include polyacrylamide, starch, clay, silica, alumina, soil, sand, polyurea, polyacrylate, or any other material capable of absorbing or adsorbing the active ingredients for a time and releasing them into or onto the seed. It is useful to make sure that the active ingredients and the solid matrix material are compatible with each other. For example, the solid matrix material should be chosen so that it can release the active ingredients at a reasonable rate, for example over a period of minutes, hours, or days.

Penetration enhancers suitable for promoting seed imbibition include agriculturally acceptable surface active compounds. The amount of penetration enhancers will usually not exceed 20% by weight, based on the total weight of the formulation. Preferably, the amount of penetration enhancers will be in the range from 2% to 20% by weight.

Colorants according to the invention are all dyes and pigments which are customary for such purposes. In this context, both pigments, which are sparingly soluble in water, and dyes, which are soluble in water, may be used. Examples which may be mentioned are the colorants, dyes and pigments known under the names Rhodamin B, C. I. Pigment Red 112 and C. I. Solvent Red 1, Pigment Blue 15:4, Pigment Blue 15:3, Pigment Blue 15:2, Pigment Blue 15:1, Pigment Blue 80, Pigment Yellow 1, Pigment Yellow 13, Pigment Red 48:2, Pigment Red 48:1, Pigment Red 57:1, Pigment Red 53:1, Pigment Orange 43, Pigment Orange 34, Pigment Orange 5, Pigment Green 36, Pigment Green 7, Pigment White 6, Pigment Brown 25, Basic Violet 10, Basic Violet 49, Acid Red 51, Acid Red 52, Acid Red 14, Acid Blue 9, Acid Yellow 23, Basic Red 10, Basic Red 108. The amount of colorants will usually not exceed 20% by weight of the formulation and preferably ranges from 1 to 15% by weight, based on the total weight of the formulation. It is generally preferred if the colorants are also active as repellents for warm-blooded animals, e. g. iron oxide, TiO₂, Prussian blue, anthraquinone dyes, azo dyes and metal phthalocyanine dyes.

Antifreezes which can be employed especially for aqueous formulations are in principle all those substances which lead to a depression of the melting point of water. Suitable antifreezes comprise alcohols such as methanol, ethanol, isopropanol, butanols, glycol, glycerine, diethylenglycol and the like. Typically, the amount of antifreeze will not exceed 20% by weight and frequently ranges from 1 to 15% by weight, based on the total weight of the formulation.

Gelling agents which are suitable are all substances which can be employed for such purposes in agrochemical compositions, for example cellulose derivatives, polyacrylic acid derivatives, xanthan, modified clays, in particular organically modified phyllosilicates and highly-dispersed silicates. A particularly suitable gelling agent is carrageen (Satiagel®). Usually, the amount of gelling agent will not exceed 5% by weight of the formulation and preferably ranges from 0.5 to 5% by weight, based on the total weight of the formulation.

Further auxiliary agents that may be present in the seed treatment formulation include solvents, wetters, dispersants, emulsifiers, surfactants, stabilizers, protective colloids, antifoams, and preservatives.

Examples of suitable solvents are water or organic solvents such as aromatic solvents (for example Solvesso® products, xylene), paraffins (for example mineral oil fractions), alcohols (for example methanol, butanol, pentanol, benzyl alcohol), ketones (for example cyclohexanone, gamma-butyrolactone), pyrrolidones (N-methylpyrrolidone, N-octylpyrrolidone), acetates (glycol diacetate), glycols, fatty acid dimethylamides, fatty acids and fatty acid esters. In principle, solvent mixtures may also be used. However, according to a particular embodiment, the formulations of the present invention contain less than 10% by weight and preferably less than 6% by weight of said organic solvents.

Suitable surface-active compounds (wetters, dispersants, emulsifiers, surfactants, protective colloids) are as defined above.

Antifoams which can be employed are all those substances which inhibit the development of foam and which are conventionally used for formulating agrochemical active ingredients. Silicone antifoams, i.e. aqueous silicon emulsions (e.g. Silikon® SRE by Wacker or Rhodorsil® by Rhodia), long chain alcohols, fatty acids and salts thereof, e.g. and magnesium stearate are particularly suitable. Usually, the amount of antifoam will not exceed 3% by weight of the formulation and preferably ranges from 0.1 to 2% by weight, based on the total weight of the formulation.

Preservatives which can be employed are all preservatives used for such purposes in agrochemical compositions. Examples which may be mentioned are dichlorophene, isothiazolenes and isothiazolones such as 1,2-benzisothiazol-3(2H)-one, 2-methyl-2H-isothiazol-3-one-hydrochloride, 5-chloro-2-(4-chlorobenzyl)-3(2H)-isothiazolone, 5-chloro-2-methyl-2H-isothiazol-3-one, 5-chloro-2-methyl-2H-isothiazol-3-one, 5-chloro-2-methyl-2H-isothiazol-3-one-hydrochloride, 4,5-dichloro-2-cyclohexyl-4-isothiazolin-3-one, 4,5-dichloro-2-octyl-2H-isothiazol-3-one, 2-methyl-2H-isothiazol-3-one, 2-methyl-2H-isothiazol-3-one-calcium chloride complex, 2-octyl-2H-isothiazol-3-one and benzyl alcohol hemiformal. Usually, the amount of preservatives will not exceed 2% by weight of the formulation and preferably ranges from 0.01 to 1% by weight, based on the total weight of the formulation.

Suitable formulations for the treatment of the growth medium, in particular the soil are, for example, granules and spray applications.

The total application rates (i.e. the total amount of the active substances employed in accordance with the invention) for the treatment of seed are, for example, 0.01 to 1000 g, especially preferably 0.1 to 750 g, more preferably 0.51 to 200 g, even more preferably 0.5 to 150 g and in particular 0.5 to 50 g per 100 kg of seed.

The active substances employed in accordance with the invention can be formulated jointly or separately.

The use according to the invention, or the method according to the invention, result in a markedly increased resistance of a plant which or the seeds of which have been exposed to abiotic stress, in particular to temperature stress.

As the strobilurins have a fungicidal action, they do not only enhance a plant's resistance to abiotic stress, but also have a preventive effect on fungal attack.

They are particularly suitable for controlling the following phytopathogenic fungi:
Alternaria species on vegetables, oilseed rape, sugar beet, fruit and rice, for example A. solani or A. alternate on potatoes and tomatoes,
Aphanomyces species on sugar beet and vegetables,
Bipolaris and Drechslera species on maize, cereals, rice and turf, for example D. maydis on maize,
Blumeria graminis (powdery mildew) on cereals,
Botrytis cinerea (gray mold) on strawberries, vegetables, flowers and grape vines,
Bremia lactucae on lettuce,
Cercospora species on maize, soybeans, rice and sugar beet,
Cochliobolus species on maize, cereals, rice (for example Cochliobolus sativus on cereals, Cochliobolus miyabeanus on rice),
Colletotricum species on soybeans and cotton,
Drechslera species and Pyrenophora species on cereals, rice, turf and maize, for example D. teres on barley or D. tritici-repentis on wheat,
Esca on grape vines, caused by Phaeoacremonium chlamydosporium, Ph. Aleophilum, and Formitipora punctata (syn. Phellinus punctatus),
Exserohilum species on maize,
Elysiphe cichoracearum and Sphaerotheca fuliginea on cucurbits,
Fusarium and Verticillium species on various plants, for example F. graminearum or F. culmorum on cereals or F. oxysporum on a multiplicity of plants such as, for example, tomatoes,
Gaeumanomyces graminis on cereals,
Gibberella species on cereals and rice (for example Gibberella fufikuroi on rice),
Grainstaining complex on rice,
Helminthosporium species on maize and rice,
Michrodochium nivale on cereals,
Mycosphaerella species on cereals, bananas and peanuts, for example M. graminicola on wheat or M. fifiensis on bananas,
Peronospora species on cabbage and bulb plants, such as, for example, P. brassicae on cabbage or P. destructoron onions,
Phakopsora pachyrhizi and Phakopsora meibomiae on soybeans,
Phomopsis species on soybeans and sunflowers,
Phytophthora infestans on potatoes and tomatoes,
Phytophthora species on a variety of plants such as, for example, P. capsici on capsicum,
Plasmopara viticola on grape vines,
Podosphaera leucotricha on apples,
Pseudocercosporella herpotrichoides on cereals,
Pseudoperonospora species on a variety of plants such as, for example, P. cubensis on cucumbers or P. humill on hops,
Puccinia species on a variety of plants such as, for example, P. triticina, P. striformins, P. hordei or P. graminis on cereals, or P. asparagi on asparagus,
Pyrenophora species on cereals,
Pyricularia oryzae, Corticium sasakg Sarocladium oryzae, S. attenuatum, Entyloma oryzae on rice,
Pyricularia grisea on turf and cereals,
Pythium spp. on turf, rice, maize, cotton, oilseed rape, sunflowers, sugar beet, vegetables and other plants, for example P. ultiumum on a variety of plants, P. aphanidermatum on turf,
Rhizoctonia species on cotton, rice, potatoes, turf, maize, oilseed rape, potatoes, sugar beet, vegetables and other plants, for example R. solani on beet and a variety of plants,
Rhynchosporium secalis on barley, rye and triticale,
Sclerotinia species on oilseed rape and sunflowers,
Septoria tritici and Stagonospora nodorum on wheat,
Erysiphe (syn. Uncinula) necatoron grape vines,
Setospaeria species on maize and turf,
Sphacelotheca rellinia on maize,
Thievaliopsis species on soybeans and cotton,
Tilletia species on cereals,
Ustilago species on cereals, maize and sugar beet, for example U. maydis on maize, and
Venturia species (scab) on apples and pears, for example V. inaequalis on apples.

The present invention also provides a seed that has been treated by the method described above. It also provides a seed obtainable by the method described above.

Still further, the present invention relates to a seed, especially an unsown seed, which comprises the above-defined active ingredients.

According to one embodiment, such a seed has a coating which comprises the above-defined active ingredients. According to a further embodiment, in such a seed the germinable part and/or natural sheath, shell, pod and/or integument comprise(s) the above-defined active ingredients. Also the active ingredients can be present in both the coating and the germinable part and/or natural sheath, shell, pod and/or integument of the seed.

The seeds treated according to the invention may also be enveloped with a film overcoating to protect the active ingredients coating. Such overcoatings are known in the art and may be applied using conventional fluidized bed and drum film coating techniques.

The seeds of the present invention can be used for the propagation of plants. The seeds can be stored, handled, planted/sowed and tilled.

Unless indicated otherwise, all amounts in % by weight refer to the weight of the total composition (or formulation).

The following examples shall further illustrate the invention without limiting it.

### EXAMPLES

In all examples exposure times and temperatures were selected to show sufficient damage to the plants so that treatment differences could be observed.

1. Emergence Behavior of Corn

The emergence behavior of corn plants the seeds of which had been treated with pyraclostrobin and which were exposed after sowing to cold and variable temperatures was studied following the guidelines for germination testing according to the Association of Official Seed Analysts (AOSA, 2005). For this purpose, corn seeds were treated with pyraclostrobin (5 g active substance per 100 kg seed). The treatment was effected by means of a HEGE 11 seed treatment apparatus. After the treatment, the seeds were sown into sand trays (2×100 seeds per tray). The sand trays were placed in an incubator and submitted to following temperature regimen: 7 days at 10° C.-4 days at 24° C.-then 10 ° C. 9, 10 and 29 days after sowing (=DAP=days after planting), the number of seeds which had given rise to plants was counted. The results are compiled as mean values in table 1. A value of 100% means that all sown seeds have given rise to plants.

TABLE 1

| Date [DAP*] | Treatment | Emergence [%] |
|---|---|---|
| 9 | — | 70 |
| | pyraclostrobin | 81 |
| 10 | — | 93 |
| | pyraclostrobin | 97 |
| 29 | — | 97 |
| | pyraclostrobin | 100 |

*DAP = days after planting

2. Plant Height (Stem Length) and Root Length

23 days after sowing (see example 1) the stem length (=length from the soil line to the meristem) and the root length of the plants was measured. The results are compiled as mean values in table 2 below.

TABLE 2

| Treatment | Stem length [cm] | Root length [cm] |
|---|---|---|
| — | 9.5 | 11.2 |
| pyraclostrobin | 11.2 | 13.3 |

3. Behavior Under Freeze Conditions

Exposure times and temperatures were selected to show sufficient damage to the plants so that treatment differences could be observed.

Corn seeds were treated with pyraclostrobin (5 g of active substance per 100 kg seed) or with azoxystrobin (5 g of active substance per 100 kg seed). The treatment was effected by means of a HEGE 11 seed treatment apparatus. One day after the treatment, the seeds were sown into pots with sandy loam soil. One part of the corn plants was exposed for 3 h to −5 ° C. ten days after sowing, and the other plants eleven days after sowing. In each case, the number of dead plants was counted one day after the freeze exposure. The results are compiled as mean percentage values (relative to 100% of living plants before exposure to freezing temperatures) in table 3 below.

TABLE 3

| Treatment | Dead plants [%] |
|---|---|
| — | 51 |
| pyraclostrobin | 36 |
| azoxystrobin | 31 |

4. Emergence Behavior of Sugar Beet

The emergence behavior of sugar beet plants the seeds of which had been treated with pyraclostrobin and which were exposed after sowing to cold temperatures was studied following the guidelines for germination testing according to the Association of Official Seed Analysts (AOSA, 2005). For this purpose, sugar beet seeds were treated with pyraclostrobin (30 g active substance per 100 kg seed). The treatment was effected by means of a HEGE 11 seed treatment apparatus. After the treatment, the seeds were sown into pots with a sandy loam soil/sand mixture (2:1 v/v; 2 seeds per pot). The pots were placed in an incubator and kept at 10° C. 13, 15, 16, 17 and 20 days after sowing (=DAP=days after planting), the number of seeds which had given rise to plants was counted. The results are compiled as mean values in table 4. A value of 100% means that all sown seeds have given rise to plants.

TABLE 4

| Date [DAP*] | Treatment | Emergence [%] |
|---|---|---|
| 13 | — | 20 |
| | pyraclostrobin | 23 |
| 15 | — | 42 |
| | pyraclostrobin | 45 |
| 16 | — | 50 |
| | pyraclostrobin | 57 |
| 17 | — | 61 |
| | pyraclostrobin | 73 |
| 20 | — | 84 |
| | pyraclostrobin | 90 |

*DAP = days after planting

5. Behavior Under Freeze Conditions

Sugar beet seeds were treated with pyraclostrobin (30 g of active substance per 100 kg seed). The treatment was effected by means of a HEGE 11 seed treatment apparatus. After the treatment, the seeds were sown into pots with a sandy loam soil/sand mixture (2:1 v/v; 2 seeds per pot). One part of the sugar beet plants was exposed for 3 h to −5° C. when they were in the BBCH growth stage 10, and the other plants when they were in the BBCH growth stage 11. In each case, the number of dead plants was counted three days after the freeze exposure. The results are compiled as mean percentage values (relative to 100% of living plants before exposure to freezing temperatures) in table 5 below.

TABLE 5

| Growth stage | Treatment | Dead plants [%] |
|---|---|---|
| 10 | — | 20 |
| | pyraclostrobin | 12 |
| 11 | — | 28 |
| | pyraclostrobin | 17 |

6. Soybean—Behavior Under Freeze Conditions

Soybean seeds were treated with pyraclostrobin (5 g of active substance per 100 kg seed). The treatment was effected by means of a HEGE 11 seed treatment apparatus. After the treatment, the seeds were sown into pots. When the soybean plants were in the BBCH growth stage 9, they were exposed for 3.5 h to −7° C. Three days after the freeze exposure, the number of dead plants was counted. The results are compiled as mean percentage values (relative to 100% of living plants before exposure to freezing temperatures) in table 6 below.

TABLE 6

| Growth stage | Treatment | Dead plants [%] |
|---|---|---|
| 9 | — | 45 |
| | pyraclostrobin | 18 |

7. Spring Wheat—Behavior Under Freeze Conditions

Spring wheat seeds were treated with pyraclostrobin (5 g of active substance per 100 kg seed). The treatment was effected by means of a HEGE 11 seed treatment apparatus. After the treatment, the seeds were sown into pots. When the spring wheat plants were in the BBCH growth stage 11, they were exposed for 2 h to −10° C. Three days after the freeze exposure, the number of dead plants was counted. The results are compiled as mean percentage values (relative to 100% of living plants before exposure to freezing temperatures) in table 7 below.

TABLE 7

| Growth stage | Treatment | Dead plants [%] |
|---|---|---|
| 11 | — | 34 |
| | pyraclostrobin | 18 |

8. Cotton—Behavior Under Freeze Conditions

Cotton seeds were treated either with pyraclostrobin (20 g of active substance per 100 kg seed) or with azoxystrobin (19 g of active substance per 100 kg seed). The treatment was effected by means of a HEGE 11 seed treatment apparatus. After the treatment, the seeds were sown into pots. When the cotton plants were in the BBCH growth stage 10, they were exposed for 4 h to −5° C. Three days after the freeze exposure, the number of dead plants was counted. The results are compiled as mean percentage values (relative to 100% of living plants before exposure to freezing temperatures) in table 8 below.

TABLE 8

| Growth stage | Treatment | Dead plants [%] |
|---|---|---|
| 10 | — | 36 |
| | pyraclostrobin | 17 |
| | azoxystrobin | 24 |

9. Canola—Behavior Under Freeze Conditions

Canola (oilseed rape) seeds were treated either with pyraclostrobin (10 g of active substance per 100 kg seed) or with trifloxystrobin (10 g of active substance per 100 kg seed). The treatment was effected by means of a HEGE 11 seed treatment apparatus. After the treatment, the seeds were sown into pots. When the canola plants were in the BBCH growth stage 10, they were exposed for 1 h to −10° C. Three days after the freeze exposure, the number of dead plants was counted. The results are compiled as mean percentage values (relative to 100% of living plants before exposure to freezing temperatures) in table 9 below.

TABLE 9

| Growth stage | Treatment | Dead plants [%] |
|---|---|---|
| 10 | — | 56 |
| | pyraclostrobin | 40 |
| | trifloxystrobin | 42 |

Field Trials:

10. Corn—Behaviour in Field Trials in Burrus Seed Farms

For avoiding fungal stress which could give misleading test results especially under cold temperature, all corn seeds were treated with Maxim XL (fludioxonil; 3.5 g of active substance per 100 kg seed) and Apron XL (mefenoxam; 1 g of active substance per 100 kg seed). A part of the seeds was additionally treated with pyraclostrobin (5 g of active substance per 100 kg seed). The treatment was effected by means of a HEGE 11 seed treatment apparatus. On Sep. 26, 2007, the seeds were sown in Burrus Seed Farms, Illinois, USA. 35 days after sowing (=DAP; days after planting), the number of intact, injured and dead plants was assessed. The results are compiled as mean percentage values (relative to total number of plants=100%) in table 10 below.

TABLE 10

| | Plants with no injury/with injury/dead plants |
|---|---|
| Treatment | [%] |
| — | 22/44/34 |
| pyraclostrobin | 34/35/29 |

11. Corn—Behaviour Under Frost Conditions in Field Trials in Beaver Crossing

For avoiding fungal stress which could give misleading test results especially under cold temperature, all corn seeds were treated with Maxim XL (fludioxonil; 3.5 g of active substance per 100 kg seed) and Apron XL (mefenoxam; 1 g of active substance per 100 kg seed). A part of the seeds was additionally treated with pyraclostrobin (5 g of active substance per 100 kg seed). The treatment was effected by means of a HEGE 11 seed treatment apparatus. The seeds were sown every 5 days starting from Sep. 6, 2007 in 1.75″ deep on clean tilled soil in Beaver Crossing, NE, USA. Frost occurred on Oct. 22/23, 2007 (−0.1° C. for 1 h), Oct. 23/24 (−0.1° C. for 1 h), 2007 and Oct. 24/25, 2007 (0° C. for 1 h, −1.1° C. for 1.5 h and 0° C. for 1 h). 47 days after sowing (=DAP; days after planting), the number emerged plants and their height was assessed. 50 DAP, the extent of dead tissue was assessed. The results are compiled as mean values in table 11 below.

TABLE 11

| | No. of plants | | |
|---|---|---|---|
| Treatment | emerged | Plant height [inches] | Dead tissue [%] |
| — | 14 | 0.5 | 98 |
| pyraclostrobin | 19 | 1.25 | 63 |

1-21. (canceled)

22. A method for increasing the resistance of a plant or of a plant's seed to abiotic stress which method comprises treating the seed from which the plant is to grow with at least one strobilurin fungicide.

23. The method as claimed in claim 22, where the at least one strobilurin fungicide is of the formula IA or IB 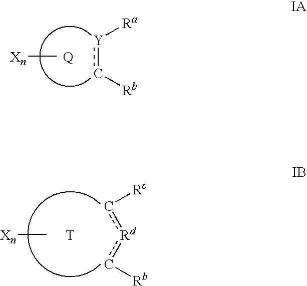
in which [symbol]
is a double bond or single bond;
R^{a} is —C(CO₂CH₃)═CHOCH₃, —C(CO₂CH₃)═NOCH₃, —C(CONHCH₃)═NOCH₃, —C(CO₂CH₃)═CHCH₃, —C(CO₂CH₃)═CHCH₂CH₃, —C(COCH₂CH₃)═NOCH₃, —C[C(═N—OR^{μ})OR^{θ}]═NOCH₃, —N(OCH₃)—CO₂CH₃, —N(CH₃)—CO₂CH₃ or —N(CH₂CH₃)—CO₂CH₃, wherein R^{μ} and R^{θ} independently are H, methyl or ethyl or together form a group CH₂ or CH₂CH₂;
R^{b} is an organic radical which is bonded directly or via an oxygen atom, a sulfur atom, an amino group or a C₁-C₈-alkylamino group; or
together with a group X and the ring Q or T, to which R^{b} and X are bonded, forms an optionally substituted bicyclic, partially or fully unsaturated system which, in addition to carbon ring members, may comprise 1, 2 or 3 heteroatoms which are independently selected from the group consisting of oxygen, sulfur and nitrogen;
R^{c} is —OC[(CO₂CH₃)═CHOCH₃, —OC(CO₂CH₃)═CHCH₃, —OC(CO₂CH₃)═CHCH₂CH₃, —SC(CO₂CH₃)═CHOCH₃, —SC(CO₂CH₃)═CHCH₃, —SC(CO₂CH₃)═CHCH₂CH₃, —N(CH₃)C(CO₂CH₃)═CHOCH₃, —N(CH₃)C(CO₂CH₃)═NOCH₃, —CH₂C(CO₂CH₃)═CHOCH₃, —CH₂C(CO₂CH₃)═NOCH₃, —CH₂C(CONHCH₃)═NOCH₃ or —CH₂NR^{π}(CO₂CH₃),
where R^{π} is H, methyl or methoxy;
R^{d} is oxygen, sulfur, ═CH— or ═N—;
n is 0, 1, 2 or 3, where, if n>1, the radicals X can be identical or different;
X is cyano, nitro, halogen, C₁-C₈-alkyl, C₁-C₈-haloalkyl, C₁-C₈-alkoxy, C₁-C₈-haloalkoxy or C₁-C₈-alkylthio, or
if n>1, two radicals X bonded to two adjacent C atoms of the Q or T ring can also be a C₃-C₅-alkylene, C₃-C₅-alkenylene, oxy-C₂-C₄-alkylene, oxy-C₁-C₃-alkylenoxy, oxy-C₂-C₄-alkenylene, oxy-C₂-C₄-alkenylenoxy or butadienediyl group, it being possible for these chains, in turn, to have attached to them one to three radicals which are independently of one another selected from the group consisting of halogen, C₁-C₈-alkyl, C₁-C₈-haloalkyl, C₁-C₈-alkoxy, C₁-C₈-haloalkoxy and C₁-C₈-alkylthio;
Y is ═C— or —N—;
Q is phenyl, pyrrolyl, thienyl, furyl, pyrazolyl, imidazolyl, oxazolyl, isoxazolyl, thiazolyl, thiadiazolyl, triazolyl, pyridinyl, 2-pyridonyl, pyrimidinyl or triazinyl; and
T is phenyl, oxazolyl, thiazolyl, thiadiazolyl, oxadiazolyl, pyridinyl, pyrimidinyl or triazinyl.

24. The method of claim 23, where the strobilurin fungicide is selected from azoxystrobin, dimoxystrobin, fluoxastrobin, kresoxim-methyl, metominostrobin, orysastrobin, picoxystrobin, trifloxystrobin, methyl (2-chloro-5-[1-(3-methylbenzyloxyimino)ethyl]benzyl)carbamate, methyl (2-chloro-5-[1-(6-methylpyridin-2-ylmethoxyimino)ethyl]benzyl)carbamate, methyl 2-ortho-[(2,5-dimethylphenyloxymethylene)phenyl]-3-methoxyacrylate and compounds of the formula IA.1 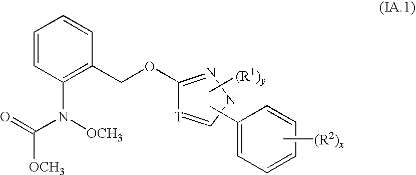
where
T is CH or N;
R¹ and R² are independently of each other halogen, C₁-C₄-alkyl or C₁-C₄-haloalkyl;
x is 0, 1 or 2; and
y is 0 or 1;
or agriculturally acceptable salts thereof.

25. The method as claimed in claim 24, where T is CH.

26. The method of claim 24, where R¹ is C₁-C₄-alkyl and R² is halogen, C₁-C₄-alkyl or C₁-C₄-haloalkyl.

27. The method of claim 24, where y is 0.

28. The method of claim 24, where x is 0 or 1.

29. The method of claim 24, where the compound of formula IA.1 is pyraclostrobin.

30. The method of claim 23, wherein said resistance is towards cold temperature and/or extremes in temperature.

31. The method of claim 30, wherein said resistance is for improving the vigor of a plant or a plant's seed which is exposed to cold temperature and/or extremes in temperature while being in the growth stage 01 to 19 of the extended BBCH scale.

32. The method as claimed in claim 31, wherein said resistance is for improving germination and/or emergence and/or increasing the plant's height and/or increasing the plant's root length.

33. The method of claim 23, wherein the plant is selected from the group consisting of cereals, legumes, oilseed rape (canola), sunflower, cotton, sugar beet, stone fruit, pome fruit, citrus fruit, banana, strawberry, blueberry, almond, grape, mango, pawpaw, potato, tomato, capsicum (pepper), cucumber, pumpkin/squash, melon, watermelon, garlic, onion, carrot, cabbage, lucerne, clover, flax, elephant grass (Miscanthus), grass, lettuce, sugar cane, tea, tobacco and coffee.

34. The method of claim 33, wherein the plant is selected from the group consisting of wheat, rye, barley, oats, rice, wild rice, maize (corn), millet, sorghum, teff, bean, pea, chickpea, lentil, soybean, oilseed rape (canola), sugar beet, cotton and peanut.

35. The method of claim 34, wherein the plant is selected from the group consisting of wheat, corn, soybean, oilseed rape (canola), sugar beet and cotton.

36. The method of claim 33, wherein said resistance is towards cold temperature and/or extremes in temperature.

37. The method of claim 36, where cold temperature is a temperature of at most 15° C.

38. The method of claim 37, where cold temperature is a temperature of at most 10° C.

39. The method of claim 38, where cold temperature is a temperature of at most 0° C.
